(19) United States
(12) Patent Application Publication
(10) Pub. No.: US 2016/0002959 A1
(43) Pub. Date: Jan. 7, 2016

(54) PROACTIVE SAFETY METHODS, DEVICES AND SYSTEMS, AND SAFETY METHODS AND DEVICES FOR BLOCKING OPERATION OF LATCHES FOR OCCUPANT INGRESS AND EGRESS CLOSURE PANELS

(71) Applicant: Magna Closures Inc., Newmarket (CA)

(72) Inventors: Houman H. Javadzadeh, Woodbridge (CA); Frank Stoof, Keswick (CA); Spiridon-Sorin S. Tudora, Richmond Hill (CA); Kar Wang Woo, Markham (CA)

(21) Appl. No.: 14/854,379

(22) Filed: Sep. 15, 2015

Related U.S. Application Data
(63) Continuation of application No. PCT/CA2014/000242, filed on Mar. 14, 2014.
(60) Provisional application No. 61/794,542, filed on Mar. 15, 2013.
(60) Provisional application No. 61/818,899, filed on May 2, 2013.

(30) Foreign Application Priority Data
Mar. 14, 2014 (CA) PCT/CA2014/000242

(51) Int. Cl. E05B 77/54; E05C 19/02; B60R 25/32; E05B 81/56; B60R 25/01; E05B 77/12; E05B 81/64

(52) U.S. Cl. CPC E05B 77/54; E05B 77/12; E05C 19/02; E05B 81/64; E05B 81/56; B60R 25/01; B60R 25/32

(57) ABSTRACT

A method for controlling a blocking component for a latch of a closure panel of a vehicle, the latch having latch components including a ratchet and pawl, the method comprising: determining whether an occupant is in the vehicle and whether a speed of the vehicle is above a first threshold; and blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open, wherein the blocking position is adjacent either the ratchet or the pawl, and restricts movement of the ratchet or pawl, respectively.

This application claims priority from and the benefit of the filing date of U.S. Provisional Patent Application No. 61/794,542, filed Mar. 15, 2013, and U.S. Provisional Patent Application No. 61/818,899, filed May 2, 2013, and the entire content of such applications is incorporated herein by reference.

### FIELD

The present disclosure relates to latch operation of vehicle closure panels for occupant ingress and egress with respect to the vehicle interior.

### BACKGROUND

It is known to configure vehicle door latches to inhibit opening of the door in the event of a vehicle crash, so as to inhibit or otherwise restrict vehicle occupants from being ejected from the vehicle. Some safety systems for latches that provide such a feature do so by way of inertial members that swing into a selected position as a result of predefined accelerations that occur during the crash event itself, to inhibit undesirable opening of the latch during the crash event. Other safety systems for latches can employ a control system that attempts to determine when a crash event is imminent and then attempts to drive a latch operation inhibiting member into position to restrict operation of the latch.

In terms of inertial members, these safety systems provide for members to inhibit operation and subsequent opening of the latch by moving the inertial member and one or more latch components towards one another during a crash event, due to inertial differences that exist between the latch components and the inertial member during the crash event. The timing of relative movement between the inertial member and the latch component(s) is configured, based at least in part, on inertial member mass, latch component(s) mass, and/or anticipated acceleration magnitude and direction imposed on the inertial member and the latch component(s) during the crash event.

In terms of existing control systems for electronically controlled inhibiting members, these safety systems provide for active actuation of the inhibiting members, based on the ability to detect a crash or pre-crash event by sensing systems (see US 2008/0269990), to automatically trigger movement of the inhibiting members into position. As such, movement of the inhibiting members is done via active control, rather than reliance solely on inertia as is the case with inertial based systems. When the vehicle is not in a crash or pre-crash condition, as sensed, the inhibiting member remains disengaged from the latch and the latch is thereby freely allowed to operate, i.e. the door can be opened or closed based only on the locked verses unlocked state of the door locking system, such as an Automatic Door Locking (ADL) system.

Other design considerations in industry related to safety systems is implementation speed of safety devices (e.g. device response time) tempered with actuation power requirements, spatial considerations for non-actuated systems as well as spatial considerations for actuated systems. A further design consideration in industry is the need for reduced cost of safety systems, including module components, to facilitate replacement and a reduction in replacement costs.

Further, during a vehicle crash or other emergency situation, vehicle doors have to be kept closed independently of handle activations or other user or external interventions (e.g. deformation of handles and/or other latch release components that cause the latch to prematurely unlatch during the crash event). In some systems, crash management is performed by the main management unit of the vehicle (also known as “vehicle body computer”), which is configured to detect a crash situation by means of crash sensors, and issues suitable control signals to the electrical latches, in order to inhibit unlocking during the crash situation and then to cause the unlocking of the electrical latches after the crash. However, during the emergency situation, failure of the main power supply of the vehicle, or interruptions or breaking of the electrical connection between the main power supply and/or the main management unit of the vehicle and the electric latches, can occur; also, the same vehicle management unit may be subject to damages during the emergency situation. As such, improvements to existing methods of latch operation, and to existing latches, are desirable.

### SUMMARY

It is an object of the present invention in at least some of its aspects to provide a configured vehicle door latch and control to obviate or mitigate at least some of the above-presented problems or disadvantages of existing safety systems.

According to one aspect of the disclosure, a latch for a closure panel for a vehicle is provided, the latch includes a ratchet, a pawl and a control system. The ratchet is movable between a closed position in which the ratchet is positioned to capture a striker and an open position in which the ratchet is positioned to release the striker. The ratchet may be biased towards the open position. The pawl is movable between a ratchet holding position in which the pawl holds the ratchet in the closed position and a ratchet release position in which the pawl permits the ratchet to move to the open position. The control system is operatively connected to the pawl to prevent movement of the pawl to the ratchet release position based in part on a vehicle occupant being present in a seat proximate the door. The control system may, for example, be mechanical, electromechanical, or electronic.

According to another aspect, a latch for a closure panel for a vehicle is provided, the latch includes a ratchet, a pawl and a control system. The ratchet is movable between a closed position in which the ratchet is positioned to capture a striker and an open position in which the ratchet is positioned to release the striker, and may be biased towards the open position. The pawl is movable between a ratchet holding position in which the pawl holds the ratchet in the closed position and a ratchet release position in which the pawl permits the ratchet to move to the open position. The control system is operatively connected to the pawl to determine whether the vehicle is being operated beyond a selected speed; and block the pawl to prevent the pawl from moving to a position to release the ratchet based at least in part on the speed determination.

According to yet another aspect, a latch for a closure panel for a vehicle is provided, the latch includes a ratchet, a pawl, a pawl blocking member, a pawl blocking actuator and a control system. The ratchet is movable between a closed position in which the ratchet is positioned to capture a striker and an open position in which the ratchet is positioned to release the striker, and may be biased towards the open position. The pawl is movable between a ratchet holding position in which the pawl holds the ratchet in the closed position and a ratchet release position in which the pawl permits the ratchet to move to the open position. The pawl blocking member is movable between a pawl blocking position in which the pawl blocking member inhibits the pawl from leaving the ratchet holding position and an open position in which the pawl blocking member permits movement of the pawl to the ratchet release position. The pawl blocking actuator is operable to move the pawl blocking member between the pawl blocking and open positions. The control system is operatively connected to the pawl blocking actuator to operate the pawl blocking actuator to move the pawl blocking member to the open position based in part on a vehicle occupant being present in a seat proximate the door, and on whether the vehicle is being operated beyond a selected speed.

According to yet another aspect, a method of operating a latch for a door for a vehicle is provided, comprising: a) using a pawl to hold a ratchet in a closed position to retain a striker so as to hold the door closed; b) determining whether the vehicle is being operated beyond a selected speed; and, c) blocking the pawl to prevent the pawl from moving to a position to release the ratchet based at least in part on the determination made in step b).

According to yet another aspect, a latch for a closure panel of a vehicle is provided, the latch including: a latch housing; a ratchet mounted to the latch housing and movable between a closed position in which the ratchet retains a striker in a slot and an open position in which the ratchet releases the striker from the slot; a pawl mounted to the latch housing and movable between a ratchet holding position in which the pawl holds the ratchet in the closed position and a ratchet release position in which the pawl facilitates ratchet movement towards the open position; and an electronically actuated blocking system having an actuated and non-actuated state, the electronically actuated blocking system positioned with respect to the pawl and having a blocking component, such that when placed in the actuated state by receipt of an actuation signal causes the blocking component to move into position to engage with the pawl to inhibit movement of the pawl to the ratchet release position; wherein the electronically actuated blocking system is placed in the actuated state by the actuation signal representing an operative state of the vehicle remaining under control of a vehicle driver.

According to yet another aspect, a latch for a closure panel of a vehicle is provided, the latch including: a latch housing; a ratchet mounted to the latch housing and movable between a closed position in which the ratchet retains a striker in a slot and an open position in which the ratchet releases the striker from the slot; a pawl mounted to the latch housing and movable between a ratchet holding position in which the pawl holds the ratchet in the closed position and a ratchet release position in which the pawl facilitates ratchet movement towards the open position; and an electronically actuated blocking system having an actuated and non-actuated state, the electronically actuated blocking system having a blocking component, such that when placed in the actuated state by receipt of an actuation signal causes the blocking component to engage with at least one of the pawl or the ratchet to inhibit movement of the ratchet to the open position; wherein the electronically actuated blocking system is placed in the actuated state by the actuation signal representing an operative state of the vehicle remaining under control of a vehicle driver.

According to yet another aspect, there is provided a latch for use with a striker, the latch comprising: latch components further comprising a ratchet, a pawl, a release mechanism, a lock mechanism, and a blocking mechanism; wherein the blocking mechanism is independent of the lock mechanism to block movement of the ratchet or the pawl.

According to yet another aspect, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; and, blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open, wherein the blocking position is adjacent either the ratchet or the pawl, and restricts movement of the ratchet or pawl, respectively.

According to yet another aspect, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open; and, when the vehicle speed is below a second threshold, automatically without occupant intervention, positioning the blocking component into a non-blocking position away from the at least one of the latch components to allow movement of the at least one of the latch components which movement would cause the latch to open.

According to yet another aspect, there is provided a method comprising: determining if wheel speed of a vehicle is above a first threshold; and, blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open; and disallowing vehicle occupant positioning of the blocking component.

According to yet another aspect, there is provided a method comprising: determining if wheel speed of a vehicle is above a first threshold; blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open; and, when the wheel speed is below a second threshold, automatically without occupant intervention, positioning the blocking component into a non-blocking position away from the at least one latch component to allow movement of the at least one latch component which movement would cause the latch to open.

According to yet another aspect, there is provided a method comprising: determining if wheel speed of a vehicle is above a first threshold; and, blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open, wherein the blocking position is adjacent either a ratchet having a striker capture position and a striker release position or a pawl of the latch, and restricts movement of the ratchet or pawl, respectively.

According to yet another aspect, there is provided a method comprising: determining if wheel speed of a vehicle is above a first threshold; and, blocking release of a latch of a closure panel of the vehicle by positioning a blocking component of the latch when the wheel speed is above the first threshold, automatically without vehicle occupant intervention and independently of a lock mechanism of the latch, into a blocking position adjacent to at least one latch component of the latch, to restrict movement of the at least one latch component which movement would cause the latch to open.

According to yet another aspect, there is provided a method comprising: blocking release of a latch of a closure panel of a vehicle by positioning a blocking component of the latch, automatically without vehicle occupant intervention, into a blocking position adjacent to at least one latch component of the latch, to restrict movement of the at least one latch component which movement would cause the latch to open, wherein the blocking component is positionable in a first position corresponding to an unblocked position for the blocking component, and a second position corresponding to the blocked position for the blocking component, and the blocking component is stable in both the first and second positions without energization in order to maintain the blocking component in either of the unblocked or blocked positions.

According to yet another aspect, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; and, blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open.

According to yet another aspect, there is provided a method for controlling a blocking component for a latch of a closure panel of a vehicle, comprising: determining whether an occupant is in the vehicle, whether a speed of the vehicle is above a first threshold, and whether a crash event has occurred; and, when the occupant is in the vehicle, the speed is above the first threshold, and the crash event has not occurred, activating the blocking component to block release of the latch.

According to yet another aspect, there is provided a method for controlling a blocking component for a latch of a closure panel of a vehicle, comprising: determining whether an occupant is in the vehicle and whether a speed of the vehicle is above a first threshold; and, when the occupant is in the vehicle and the speed is above the first threshold, activating the blocking component to block release of the latch.

In accordance with further aspects of the disclosure, there is provided an apparatus such as a control system, a method for adapting same, as well as articles of manufacture such as a computer readable medium or product and computer program product or software product (e.g., comprising a non-transitory medium) having program instructions recorded thereon for practicing the method of the disclosure.

### BRIEF DESCRIPTION OF THE DRAWINGS

The foregoing and other aspects will now be described by way of example only with reference to the attached drawings, in which:

FIG. 1 is a perspective view of a vehicle;

FIG. 2 is a plan view of a latch in the vehicle shown in FIG. 1;

FIG. 3 is a plan view of a portion of the latch shown in FIG. 2;

FIG. 4 is a block diagram illustrating a control system for the latch shown in FIG. 2;

FIG. 5 is a table of sensor statuses and the resultant action by the control system shown in FIG. 4;

FIG. 6 is a graph illustrating a force/displacement relationship for an actuator for the portion of the latch shown in FIG. 3;

FIG. 7 is an alternative table of sensor statuses and the resultant action by the control system shown in FIG. 4;

FIG. 8 is a block diagram illustrating various release chain options for the latch shown in FIG. 1;

FIG. 9 is a plan view of an alternative embodiment of the controlled latch of FIG. 3;

FIG. 10 is a perspective view of a further embodiment of the controlled latch of FIG. 3;

FIG. 11 is another alternative table of sensor statuses and the resultant action by the control system shown in FIG. 4; and,

FIG. 12 is a flowchart flow chart illustrating operations of modules within a control system for controlling a blocking component for a latch of a closure panel of a vehicle.

### DETAILED DESCRIPTION

In the following description, details are set forth to provide an understanding of the disclosure. In some instances, certain software, circuits, structures, techniques and methods have not been described or shown in detail in order not to obscure the disclosure. The term “control system” is used herein to refer to any machine for processing data, including the data processing systems, computer systems, electronic control units, controllers, and network arrangements described herein. Aspects of the present disclosure may be implemented in any computer programming language provided that the operating system of the control system provides the facilities that may support the requirements of the present disclosure. Any limitations presented would be a result of a particular type of operating system or computer programming language and would not be a limitation of the present disclosure. Aspects of the present disclosure may also be implemented in hardware or in a combination of hardware and software.

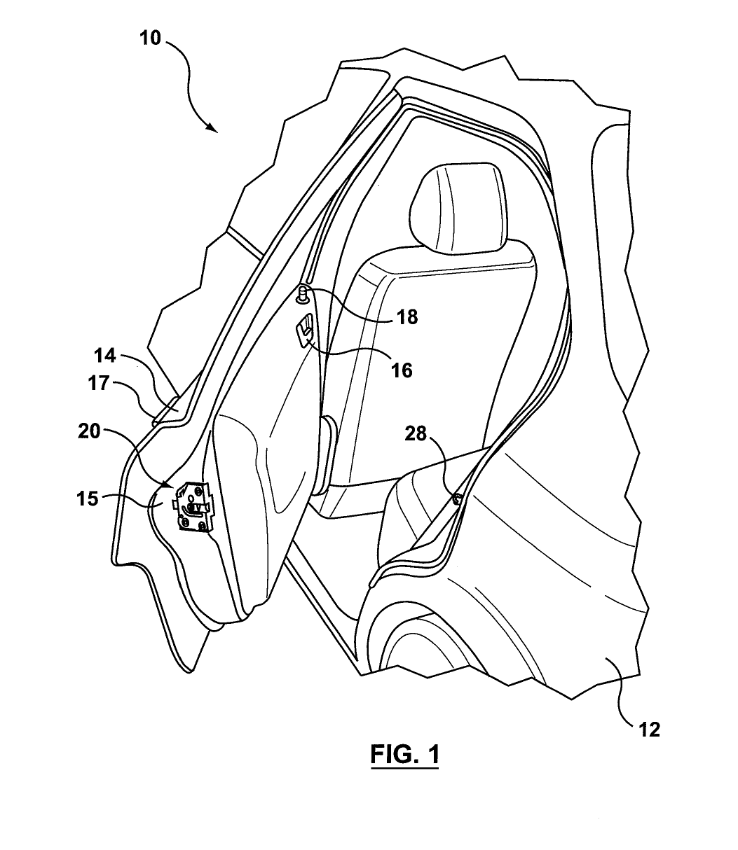

FIG. 1 is a perspective view of a vehicle 10 that includes a vehicle body 12 and at least one vehicle door 14 (also referred to as closure panel 14). The vehicle door 14 includes a latch 20 that is positioned on an edge face 15 and which is releasably engageable with a striker 28 on the vehicle body 12 to releasably hold the vehicle door 14 in a closed position. An outside door handle 17 and an inside door handle 16 are provided for opening the latch 20 (i.e. for releasing the latch 20 from the striker 28) to open the vehicle door 14. An optional lock knob 18 is shown and provides a visual indication of the lock state of the latch 20 and may be operable to change the lock state between an unlocked position and a locked position.

The closure panel 14 (e.g. occupant ingress or egress controlling panels such as but not limited to vehicle doors and lift gates/hatches) is connected to the vehicle body 12 via one or more hinges (not shown) and the latch 20 (e.g. for retaining the closure panel 14 in a closed position once closed). It is also recognized that the hinge can be configured as a biased hinge that can be configured to bias the closure panel 14 towards the open position and/or towards the closed position. The closure panel 14 can have a mating latch component 28 (e.g. striker) mounted thereon for coupling with a respective latch 20 mounted on the vehicle body 12 (not shown). Alternatively, as shown in FIG. 1, the latch 20 can be mounted on the closure panel 14 and the mating latch component 28 can be mounted on the body 12.

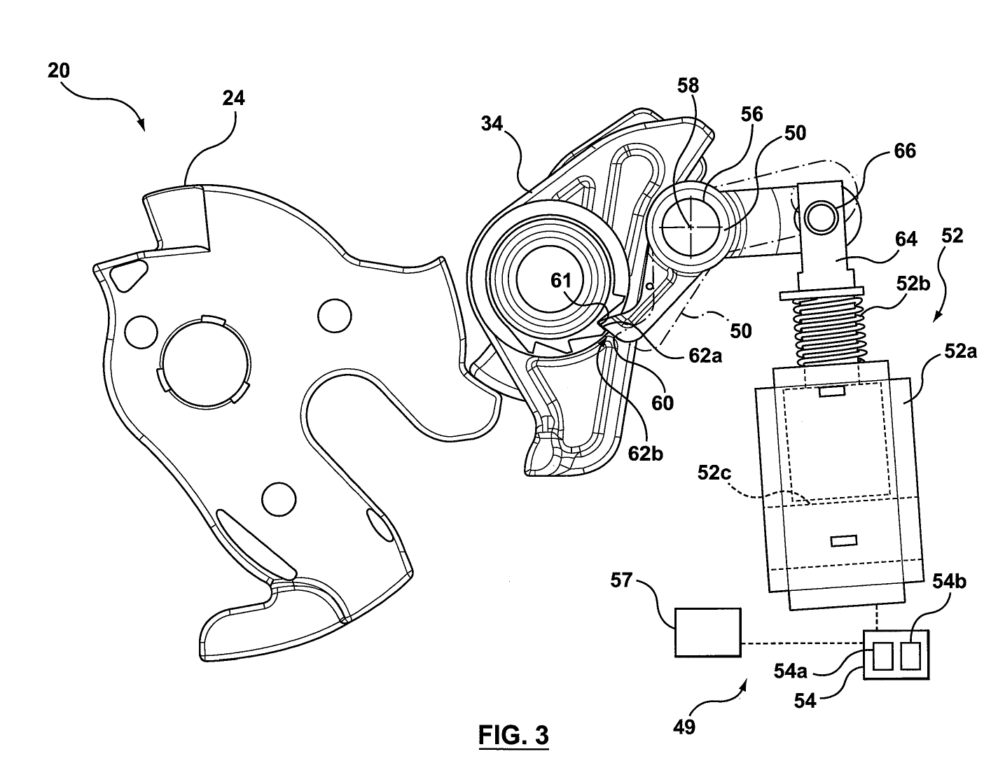

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. It is also recognized that the closure panel 14, as discussed herein with respect to operation of blocking system 49 (see FIG. 3), will not typically be used as an access panel for vehicle systems such as engine compartments and traditional trunk compartments of automotive type vehicles 10. The closure panel 14 can be opened to provide access to the vehicle 10 interior, or closed to secure or otherwise restrict access to and from the vehicle 10 interior by vehicle occupant(s). It is also recognized that there can be one or more intermediate open positions (e.g. unlatched position) of the closure panel 14 between a fully open panel position (e.g. unlatched position) and fully closed panel position (e.g. latched position), as provided at least in part by the panel hinges.

Movement of the closure panel 14 (e.g. between the open and closed panel positions) can be electronically and/or manually operated, where power assisted closure panels 14 can be found on minivans, high-end cars, or sport utility vehicles (SUVs) and the like. As such, it is recognized that movement of the closure panel 14 can be manual or power assisted during operation of the closure panel 14 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched). It is recognized that the partially open configuration of the closure panel 14 can also include a secondary lock position.

In terms of vehicles 10, the closure panel 14 may be a driver/passenger door, a lift gate, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle at the front, side or back of the door, as the application permits. It is recognized that the body 12 can be represented as a body panel of the vehicle 10, a frame of the vehicle 10, and/or a combination frame and body panel assembly, as desired.

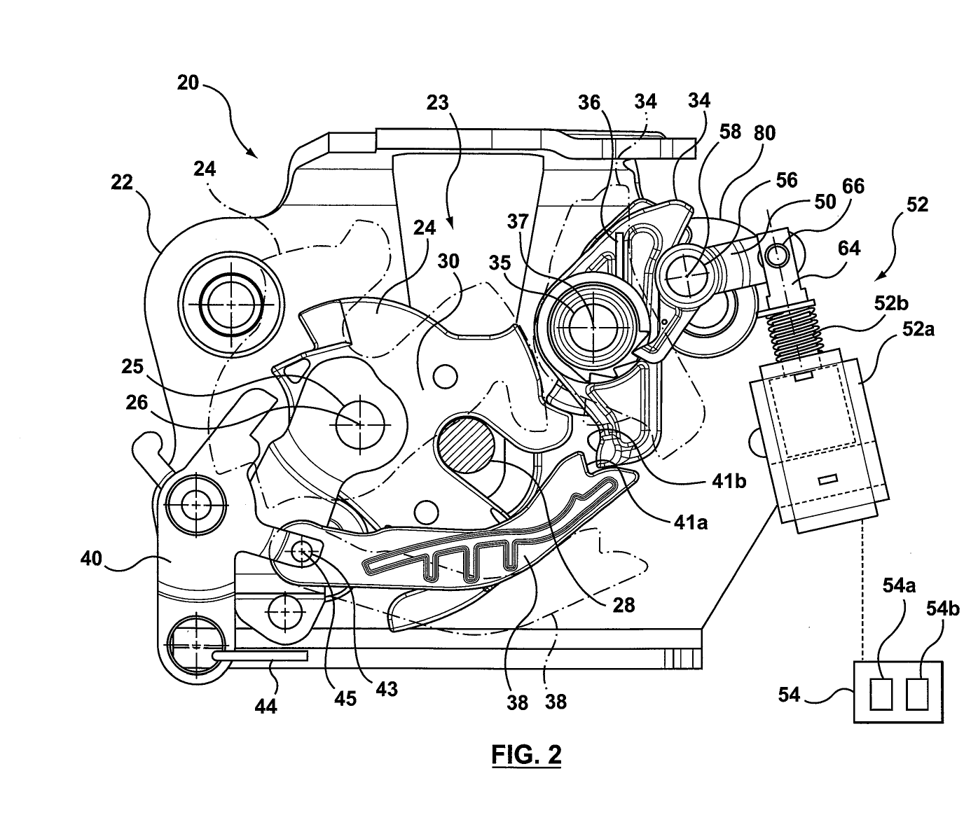

FIG. 2 is a front view of the latch 20. The latch 20 includes a housing 22 (a portion of which is shown in FIG. 2) in which a ratchet 24 is pivotally mounted by means of a pin joint 25 for rotation about a ratchet pivot axis 26. The ratchet 24 is movable between a closed position (FIG. 2) wherein the ratchet 24 is positioned to retain the striker 28 in a fishmouth 23 (i.e. a slot) in the housing 22, and an open position (shown in dashed outline in FIG. 2) wherein the ratchet 24 is positioned to release the striker 28. In the view shown in FIG. 2, the ratchet 24 rotates counterclockwise from the closed position to the open position.

The ratchet 24 is biased towards the open position via a ratchet biasing member 30. The biasing member 30 may be any suitable type of biasing member, such as, for example, a torsion spring. A pawl 34 is provided and is pivotally connected to the housing 22 via a pin joint 35 about a pawl axis 37 for pivotal movement between a ratchet holding position (FIG. 2) wherein the pawl 34 is positioned to hold the ratchet 24 in the closed position and a ratchet release position (shown in dashed outline in FIG. 2) wherein the pawl 34 permits the movement of the ratchet 24 out of the closed position to the open position. In the view shown in FIG. 2, the pawl 34 rotates counterclockwise from the ratchet holding position to the ratchet release position. The pawl 34 is biased towards the ratchet holding position by a pawl biasing member 36 which may be any suitable type of spring such as a torsion spring.

The ratchet 24 may be holdable by the pawl 34 in a primary closed position in which the ratchet 24 holds the striker 28 at a first depth in the fishmouth 23, and an optional secondary closed position in which the ratchet 24 holds the striker 28 at a second depth that is less than the first depth in the fishmouth 23. When holding the ratchet 24 in the primary closed position, the pawl 34 is in a primary ratchet holding position. When holding the ratchet 24 in the secondary closed position, the pawl 34 is in a secondary ratchet holding position, in which the pawl 34 is rotated by a small angle counterclockwise (in the view shown in FIG. 3) relative to the primary ratchet holding position. The positions shown in FIGS. 2 and 3 are the primary closed and ratchet holding positions for the ratchet 24 and pawl 34 respectively.

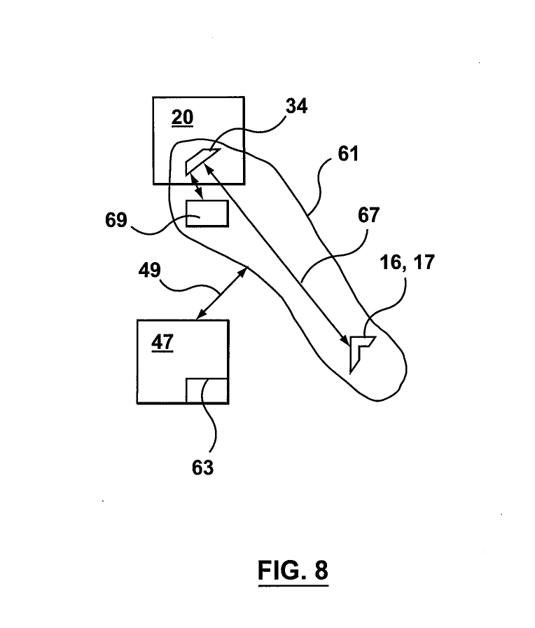

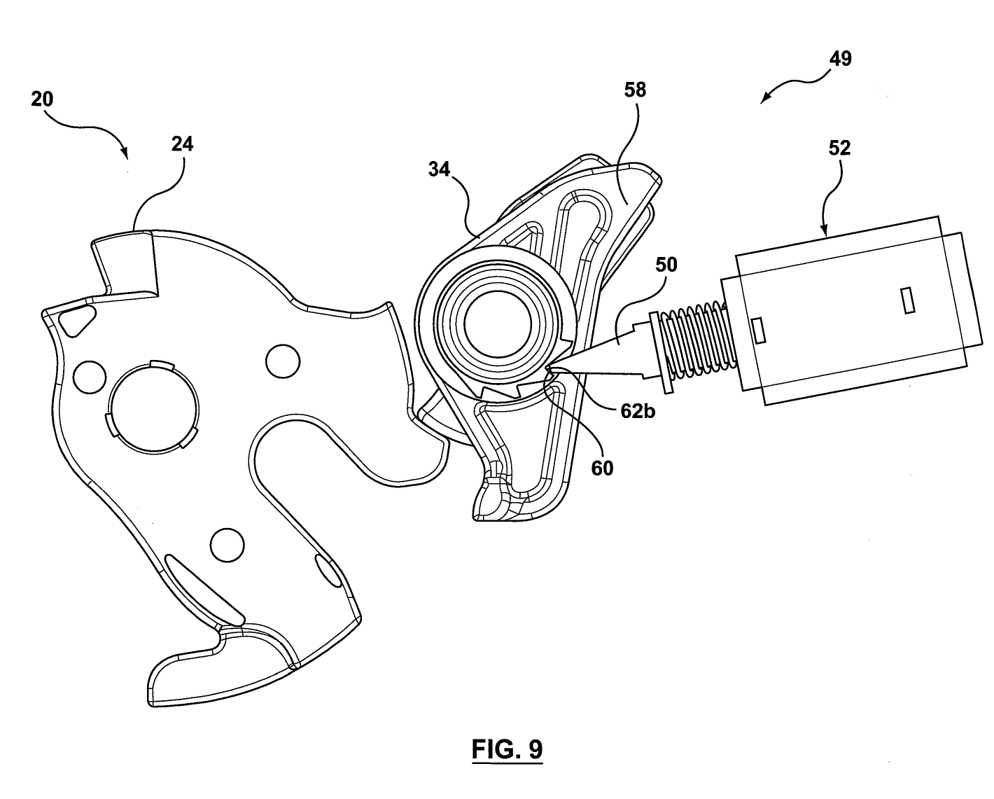

It is recognized that the latch 20 is can be placed into a latched state by rotating the ratchet 24 into position to retain the striker 28 within the slot 23, and an unlatched state by rotating the ratchet 24 out of position to provide for the striker 28 to be released or otherwise removed from within the slot 23. Referring to FIG. 8, an automatic door lock (ADL) system 47 provides for inhibiting operation of a door release system 61 (also referred to as a release chain) used to operate the latch 20 from the closed/latched position to the open/unlatched position (i.e. allow the ratchet 24 to rotate so that the striker 28 is released from the slot 23—see FIG. 1), recognizing that once unlatched the vehicle door 14 is in a position to be opened to permit ingress or egress of vehicle occupants (e.g. driver, passenger) from the interior of the vehicle 10. Operation of the ADL is typically actuated automatically when the vehicle 10 surpasses a preset vehicle speed (e.g. 10 km per hour), when accelerating past a preset acceleration threshold, after a specified time, and/or when put into gear or due to any other means as configured, such that the automatic door lock (ADL) system 47 is actuated to inhibit the ability of the door release system 61 (e.g. interior/exterior door handle 16,17, etc., see FIG. 1) to unlatch the latch 20.

It is also recognized that the doors 14 can be locked manually by means of the vehicle's central locking system before the start of propelling the vehicle 10, as well as unlocked manually and thus able to override operation of the ADL system 47 by the driver or other occupant of the vehicle 10. It is important to note that the effect of the ADL system 47 to automatically decouple operation of the door release system 61 from the latch 20, thus effectively providing for operation of the door release system 61 without unlatching the latch 20, can be overridden by the vehicle occupant(s) by their manual/electronic manipulation of the door 14 lock/unlock switches (or physical door latch knob/indicator 18). In other words, manual disengagement of the ADL can be performed by the vehicle occupant (i.e. under control of the vehicle occupant) when the vehicle 10 is over the preset ADL speed threshold. As such, it is recognized that automatic door locking systems 47 can be optional and/or can be de-activated by the driver after they are engaged automatically. Typically, once the ADL system 47 is engaged, thus decoupling the door release system 61 from unlatching the latch 20, the ADL system 47 stays engaged until manually disengaged (i.e. overridden) by the driver or passenger.

For example, for keypads, keyless entry systems and conventional locks, some vehicles 10 today have four or five different ways to unlock (e.g. disengage the ADL system 47) the doors 14 and thus override operation of the ADL system 47, such as but not limited to: with a key; by pressing an unlock button inside the vehicle 10; by using a combination lock on the outside of the door 14; by pulling up or pushing sideways the knob 18 on the inside of the door 14; and/or with a keyless-entry remote control (e.g. FOB). In some vehicles 14 that have power door locks, an lock/unlock switch actually sends power to actuators that unlock (e.g. disengage the ADL system 47) the door 14 by engaging the door release system 61 with operation of the latch 20 (i.e. allowing operation of the door release system 61 to influence opening of the latch 20). In the case of power door locks, a vehicle computer (not shown) can monitor all of the possible sources of an “unlock” or “lock” signal to result in engagement or disengagement of the ADL system 47 with respect to the door release system 61. The vehicle computer can monitor a door-mounted touchpad and unlock (e.g. disengage the ADL system 47) the doors 14 when the correct code is entered. The vehicle computer can monitor a radio frequency and unlock (e.g. disengage the ADL system 47) the doors 14 when the vehicle computer receives the correct digital code from the radio transmitter in the key fob, and can also monitor the occupant accessible door switches inside the vehicle 10. When the vehicle computer receives a signal from any of these sources, the vehicle computer can provide power to the ADL system 47 that allows for the door release system 61 to be operated by the vehicle occupant to open or close the doors 14 (e.g. pull on the handle to unlatch the latch 20 or otherwise operate a motor to unlatch the latch 20).

Referring to FIG. 8, the door release system 61 (also referred to as the release chain) can be considered as a grouping of release elements used by the vehicle operator (or occupant) to unlatch the latch 20 and open the door 14. For example, the door release system 61 can include a handle 16,17, a force member 67 (e.g. a rod and/or cable) to transfer actuation of the handle 16,17 to operation of the latch 20 (e.g. to cause the pawl 34 to be displaced from its latch position) and thus providing for the ratchet biasing member 30 to rotate the ratchet 24 and cause the striker 28 to be released from the slot 23 as the door 14 is moved into the open position (see FIG. 3). Once the door is opened, the vehicle occupant (driver/passenger) can enter or exit the vehicle 10 interior as the case may be. The pawl 34 can also be considered as part of the door release system 61, such that movement of the pawl 34 is under control of other components of the door release system 61 in cooperation with one another.

Operation of the door release system 61 can be affected by a power-door-lock actuator 63 (as part of the ADL system 47) positioned adjacent to the latch 20. A rod 67 can connect the actuator 63 to the latch 20, and another rod 67 can connect the latch 20 to the knob 18 that sticks up out of the top of the door 14 (see FIG. 1). When the actuator 63 is actuated, the actuator 63 connects the door handle 16,17 via the force member 67 to the latch 20, thus providing for the door handle 16,17 to be the opening mechanism for the latch 20 and/or door 14 itself. Otherwise when the actuator 63 is not actuated, the door handle 16,17 is disconnected from the latch 20 via disengagement of the force member 67 there-between, and thus operation of the door handle 16,17 will not unlatch the latch 20.

Further, the door release system 61 can include the door latch 20 configured as an electrical door latch, whereby the ratchet 24 is selectively rotatable with respect to the striker 28 fixed to a door post (e.g. vehicle body 12), in order to latch and unlatch the door 14. The electrical door latch 20 includes the pawl 34 that selectively engages the ratchet 24 to inhibit the ratchet 24 from rotating. The electrical door latch 20 can include an electric motor 69, which is electrically connected to a main electric power supply of the vehicle 10 (for example to the 12V battery of the same vehicle), in order to directly or indirectly drive the pawl 34, via an electrically-operated actuator coupled to the electric motor 69. As such, the electric motor 69 and associated electrically-operated actuator are used to displace the pawl 34 out of the latched position and thus provide for opening of the door 14, rather than manual operation of the force member 67 (e.g. cable) via operation of the door handle 16,17 by the vehicle occupant. It is recognized that the door release system 61 can include the handle 16,17 and associated force member 67 to operate the pawl 34, the electrically-operated actuator coupled to the electric motor 69 to operate the pawl 34, or both the handle 16,17 and associated force member 67 to operate the pawl 34 and the electrically-operated actuator coupled to the electric motor 69 to operate the pawl 34 depending upon opening conditions and circumstance, as desired.

As such, it is recognized that the latch 20 can be mechanically operated by manipulation of the pawl 34 (or other latch 20 components—e.g. ratchet 24) by mechanically operated force members 67 via the handle 16, 17 and/or electronically operated by manipulation of the pawl 34 (or other latch 20 components—e.g. ratchet 24) though activation of the electric motor 69 and associated electrically-operated actuator.

Referring again to FIG. 2, further to the above, the door release system 61 can also include a lock link 38 pivotally connected to the release lever 40 by way, for example of a pin joint 43, for pivoting movement about a lock link axis 45. The lock link 38 can be movable between an unlocking position wherein the lock link 38 operatively connects a release lever 40 (FIG. 2) to the pawl 34, and a locking position (shown in dashed outline in FIG. 2) wherein the lock link 38 operatively disconnects the release lever 40 from the pawl 34. In the view shown in FIG. 2, the lock link 38 pivots clockwise from the unlocking position to the locking position.

The release lever 40 can be movable between a rest position (FIG. 2) and an actuated position and may be biased towards the rest position by a release member biasing member (not shown), which can, for example, be a torsion spring. In the view shown in FIG. 2, the release lever 40 rotates counterclockwise from the rest position to the actuated position. When the lock link 38 is in the unlocking position, movement of the release lever 40 to the actuated position drives the lock link 38 rightwardly (in the view shown in FIG. 2) along a first path to bring the pawl 34 from the ratchet holding position to the ratchet release position (via engagement of pawl actuation surface 41a on the lock link 38 with receiving surface 41b on the pawl 34).

When the lock link 38 is in the locking position, the orientation of the lock link 38 is such that movement of the release lever 40 to the actuated position drives the lock link 38 rightwardly along a second path such that the lock link 38 misses the pawl 34.

The movement of the lock link 38 between the locking and unlocking positions may be carried out by a lock lever (not shown), that may itself be actuated by any number of means, such as by one or more of: a key cylinder, the lock knob 18, and a motor (not shown).

In some embodiments, the release lever 40 may be an inside door release lever, which is connected to the inside door handle 16 (FIG. 1) via a linkage that may include a cable 44. In other embodiments, the release lever 40 may be an outside door release lever that is connected to the outside door handle 17 (FIG. 1). In still other embodiments, the release lever 40 may be a common release lever that is actuated by both an inside release lever and an outside release lever.

Some safety systems operate on the condition that they are only engaged in the event of detection of a crash or pre-crash (i.e. imminent crash) of the vehicle 10. This engagement of safety systems is dependent upon detection and identification of a crash or pre-crash event.

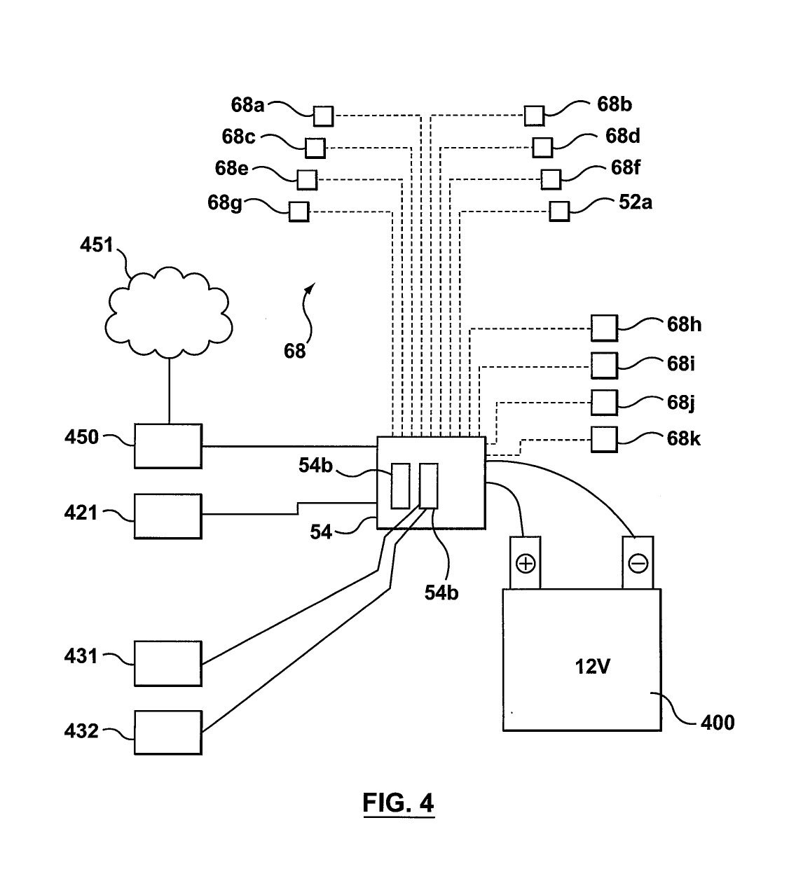

Referring to FIG. 4, the detection and identification of pre-crash and crash events experienced by the vehicle 10 may use a control system 54 (e.g. Body Control Unit (BCU)) to receive input from various sensors 68 and to use that sensory information to determine/identify pre-crash threat events and crash events, as well as to identify post crash events (i.e. when the vehicle 10 is no longer in the circumstances of the pre-crash or crash event, such as when the vehicle has come to rest or otherwise returns to safe control of the vehicle driver). As such, the control system 54 is electronically connected to at least one sensor 68 to transmit data signals from the at least one sensor 68 to the control system 54 during pre-crash, crash and post crash events experienced by the vehicle 10. It is recognized that the sensor 68 can be a pressure sensor or an acceleration sensor or any other suitable sensor. These sensors 68 can find application in automotive vehicle doors 14 as side impact sensors 68. In addition, a remote accelerometer 68 electronically connected to the control system 54 can be used to provide information and data concerning vehicle longitudinal and latitudinal acceleration indicative of pre-crash, crash and/or post crash events as interpreted by the control system 54. Those skilled in the art recognize that acceleration as used herein is also meant to include deceleration.

As such, when the vehicle 10 is under the influence of a pre-crash, crash and/or post crash event, as sensed by the control system 54, the vehicle 10 is considered to be out of operative control by the vehicle driver. When the control system 54 identifies via the sensor 68 input that the vehicle is experiencing a pre-crash, crash and/or post crash event, this identification can be defined as a crash state or inoperative state of the vehicle 10. When the control system 54 identifies via the sensor 68 input that the vehicle is not experiencing (or has experienced) a pre-crash, crash and/or post crash event, this identification can be defined as an operative state of the vehicle 10.

The vehicle door 14 can be equipped with a sensor 68, that can be a pressure sensor 68 or an accelerometer sensor 68 or any other type of sensor 68. Also, it is recognized that proximity sensors 68 can be used to detect the proximity of objects (e.g. other cars) to the vehicle 10. The sensor 68 is electronically coupled to the control system 54 and transmits data signals to the control system 54 indicative of the respective “crash” event, for example when the sensor 68 signals exceed (e.g. higher or lower) or otherwise meet (e.g. equal to) a certain sensor threshold or condition stored in the control system 54. The control system 54 can optionally be further electronically connected to a Lane Departure Warning sensing system 68, a blind spot detection sensing system 68, an Adaptive Cruise sensing system 68, and/or a brake pedal sensor 68 to determine position of the brake pedal, vehicle brakes to determine brake pressure, steering wheel to determine the angle of the steering wheel, wheel speed sensors 68 to determine wheel speed and vehicle roll rate, and/or a remote accelerometer 68 to determine longitudinal and latitudinal acceleration and/or deceleration. As described further below, the control system 54 further may have a memory 54b, which may be a PROM, EPROM, EEPROM or Flash memory, or any other memory, with tables resident therein which have data and programs to permit the control system 54 to process incoming data signals from the sensors 68 to compare against stored thresholds or condition logic to determine whether a pre-crash event is occurring, or whether a crash event has occurred, or whether the vehicle is in a post crash event state.

As used herein pre-crash threat events can be defined as those conditions or events, as detected by one of the systems and/or sensors mentioned above, that indicate that a crash between the vehicle and an object is imminent. Crash events, as used herein, can be defined as those conditions or events, as detected by one of the systems and/or sensors as set forth above, which indicate the vehicle 10 is experiencing a collision with another adjacent object. And, post crash events can be defined as those conditions that indicate that the crash condition has ended, as detected by the aforementioned systems and/or sensors.

Operation of the control system 54 to detect one of the crash event states discussed above can include determining whether a pre-crash threat event is imminent. The control system 54 can determine whether a pre-crash threat event is imminent by processing inputs from at least one of the sensors 68 (e.g. Lane Departure Warning System, Blindspot Detection System, Adaptive Cruise Control, brake pedal position, brake pressure, steering wheel angle, wheel speed, latitudinal and longitudinal acceleration/deceleration, crash sensor input such as pressure from side impact crash sensors, and/or input from accelerometer sensors). The control system 54 processes these signal inputs and makes a determination as to whether they constitute a pre-crash threat event when compared to predefined thresholds or condition logic. Similarly, the control system 54 can process these signal inputs and make a determination as to whether they constitute a crash event or a post crash event when compared to the predefined thresholds or condition logic. For example, the control system 54 can determine whether the crash event has ended by processing accelerometer input from the accelerometer and the accelerometer sensors 68 or from the aforementioned sensor 68 systems to determine whether the vehicle 10 has stopped moving. If it is determined that a post crash event has occurred, the control system 54 can act to release the blocking system 49 as further described below.

In view of the above, it is recognized that the blocking system 49 can be engaged and thus actively restrict operation of the latch 20 from going from the latched to unlatched state even in the absence of detection of a pre-crash, crash, or post crash event. As such, the blocking system 49 can be operated by the control system 54 to restrict movement of the pawl 34 (or other latch component—e.g. ratchet 24, pawl blocking member 50, etc.) when the vehicle remains in control (e.g. operative state) by the vehicle occupant.

Referring to FIG. 3, shown by example is the electronically actuated blocking system 49 of the latch 20. The blocking system 49 can include a pawl blocking member 50 (e.g. a blocking component 50), a pawl blocking actuator 52 and a control system 54. The pawl blocking member 50 can be pivotally connected to the latch housing 22 via a pin joint 56 for pivotal movement about a pawl blocking axis 58. The pawl blocking member 50 is movable between a pawl blocking position (FIG. 3) in which the pawl blocking member 50 inhibits or otherwise restricts the pawl 34 from leaving the ratchet holding position and an open position (shown in dashed outline in FIG. 3) in which the pawl blocking member 50 permits movement of the pawl 34 to the ratchet release position.

As such, in this configuration, the electronically actuated blocking actuator 52 indirectly affects the position of the pawl 34 via action the end member 64 on the intervening pawl blocking member 50. As such, linear movement of the end member 64 is translated into pivotal movement of the pawl blocking member 50 in order to engage the pawl blocking member 50 with the pawl 34. One advantage of this indirect engagement of the pawl 34 by the blocking actuator 52 is to reduce the magnitude of actuation force generated by the blocking actuator 52 used to hold/retain the pawl 34 in the blocked position. Further, the blocking component 50 (e.g. pawl blocking member 50) can be retained in the blocking position without constant application of the generated actuation force using a multi-position biasing member 80 (e.g. toggle switch), see FIG. 2, mounted to the housing 22.

In the pawl blocking position, the pawl blocking member 50 has a blocking surface 60 (e.g. detent) that can engage a first engagement surface 62a on the pawl 34 when the pawl 34 is in the primary ratchet holding position (shown in FIG. 3). The blocking surface 60 on the pawl blocking member 50 engages a second engagement surface 62b on the pawl 34 when the pawl 34 is in the secondary ratchet holding position (not shown). It is recognized that the surface 62a and surface 60 can be spaced apart from one another when engaged, by a spatial separation 61, e.g. when the blocking component 50 is positioned in the pawl blocking position.

The blocking actuator 52 is operable to move the pawl blocking member 50 between the pawl blocking and open positions. In some embodiments, the blocking actuator 52 may be a linear actuator that has an end member 64 (e.g. a blocking component 50 such as a solenoid arm) that is pivotally connected to the pawl blocking member 50 via a pin joint connection 66 that has sufficient play to accommodate the small changes in position of the end member 64 relative to the end of the pawl blocking member 50 that result from extension and retraction of the end member 64. In some embodiments, the linear actuator 52 may be in the form of a solenoid, more specifically a micro magnetic latching solenoid 52a, with a biasing member 52b thereon. The biasing member 52b may be a helical coil spring or other elastic element that abuts between a housing of the solenoid 52a and a push surface on the end member 64. The biasing member 52b urges the end member 64 towards the extended position which corresponds to the open position for the pawl blocking member 50. The actuator 52 further includes a permanent magnet 52c that applies an attraction force on the end member 64 so as to urge the end member 64 towards the retracted position. It is recognized that the blocking actuator 52 can be used to position the blocking component 50 in the two or more positions (e.g. blocking position and unblocked position). The blocking actuator 52 can also be a micro motor coupled to the blocking component 50, in order to move the blocking component 50 into the various blocking and unblocked positions, as desired.

The biasing member 52b, the solenoid 52a and the magnet 52c may all be configured so that any forces required to be applied by the solenoid are below selected levels, in order to bring the pawl blocking member 50 to the open or pawl blocking positions.

Referring to FIG. 9, shown is an alternative embodiment of the electronically actuated blocking system 49, such that the blocking component 50 (e.g. the solenoid arm 64) is in direct cooperation/engagement with the pawl 34. Also, it is realized that the blocking component 50 (e.g. the solenoid arm 64 or the blocking member 50) can be positioned in the latch 20 so as to engage with an engagement surface (e.g. detent) of the ratchet 24 (not shown).

In view of the above, and referring to FIGS. 1 and 2 as an example, the latch 20 for the closure panel 14 of the vehicle 10 can include the latch housing 22; the ratchet 24 mounted to the latch housing 22 and movable between a closed position in which the ratchet 24 retains the striker 28 in the slot 23 and an open position in which the ratchet 24 releases the striker 28 from the slot 23; the pawl 34 mounted to the latch housing 22 and movable between a ratchet holding position in which the pawl 34 holds the ratchet 24 in the closed position and a ratchet release position in which the pawl 34 facilitates ratchet 24 movement towards the open position; and an electronically actuated blocking system 49 having an actuated and non-actuated state, the electronically actuated blocking system 24 positioned with respect to the pawl 34 (e.g. mounted inside the latch housing 22 or mounted at least partially outside of the latch housing 22) and having a blocking component 50, such that when placed in the actuated state by receipt of an actuation signal causes the blocking component 50 to engage with the pawl 34 to inhibit movement of the pawl 34 to the ratchet release position; wherein the electronically actuated blocking system 49 is placed in the actuated state by the actuation signal representing an operative state of the vehicle 10 remaining under control of the vehicle driver.

For example, the actuation signal can be a sensor 68 signal interpreted by the control system 54 of the electronically actuated blocking system 49 as representing the operative state based on matching the sensor 68 signal to a stored sensor threshold. Alternatively, the actuation signal can be a switch signal sent by a vehicle controller (e.g. BCU) separate from the electronically actuated blocking system 49, such that the vehicle controller generates the switch signal based on matching a sensor signal to a sensor threshold. As discussed above, the operative state can be defined as opposite to a crash state representing at least one of the pre-crash event, the crash event, or the post crash event, such that the crash state represents an inoperative state of the vehicle 10 as out of control of the vehicle driver.

As shown by example in FIG. 3, the blocking component 50 is positionable in a first position corresponding to an unblocked position for the blocking component 50, and a second position corresponding to a blocked position for the blocking component 50, such that the blocking component 50 can be stable in both the first and second positions without continued receipt of the actuation signal, or other energization, in order to maintain the blocking component 50 in either of the unblocked or blocked positions. This stability can be provided by a multiple position biasing member 80 that can retain the blocking component 50 in either the first position or the second position once positioned therein by the blocking actuator 52. For example, the multiple position biasing member 80 can be a toggle switch. Alternatively, the multiposition biasing member 80 can be provided as a magnet and internal solenoid spring of the blocking actuator 52 used to maintain the blocked or unblocked positions of the blocking component 50. As such, blocking release of the latch 20 can be done by positioning the blocking component 50 in to the blocking position adjacent to at least one of the latch components (e.g. ratchet 24 or pawl 34) in order to restrict movement of the at least one of the latch components which would cause the latch 20 to open, the positioning based on when the occupant is in the vehicle 10 and based on when the vehicle speed is above a first speed condition (also referred to as threshold).

It is recognized that the control system 54 bases movement of the blocking component 50 into the blocking position based on whether there is an occupant in the vehicle 10 (e.g. sensed by a seat pressure sensor 68b) and based on whether the vehicle 10 speed is at or above a speed condition or threshold. As such, the control system 54 is not simply sensing speed as part of a broader determination of a crash state of the vehicle 10 (e.g. a pre-crash condition). The control system 54 compares vehicle 10 speed to a fixed or pre-determined threshold/condition and setting the blocking component 50 into the blocking position is based on the threshold/condition being satisfied. A pre-crash may only use speed as part of a larger algorithm combined with other sensed variables (e.g. proximity of the vehicle to an object, rate of acceleration, etc.) to determine whether a crash is about to occur but it would not be a one to one relationship that the threshold/condition speed is passed as a condition upon which the blocking component 50 would be moved into the blocking position.

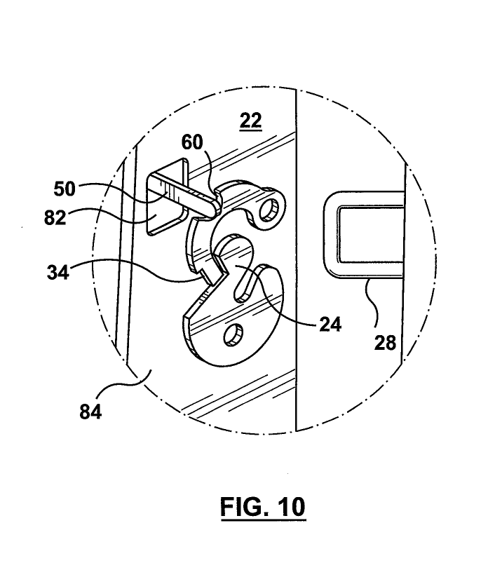

It is recognized that an advantage of the blocking system 49 arrangement shown in FIGS. 2 and 3 is that the blocking system 49 including the blocking component 50 and the blocking actuator can be housed within the housing 22, thereby providing for an integral housing 22 exterior wall that can be sealed against undesirable penetration of moisture, salt, and other potentially latch 20 component corrosive materials. The electronically actuated blocking system 49 can include the blocking component 50 contained within an interior of the latch housing 22. Alternatively, the latch 20 in FIG. 10 shows the blocking component 50 engaging with the pawl 34 within an interior of the latch housing 22 through an aperture 82 in an external wall 84 of the latch housing 22.

According to one embodiment, the blocking component 50 is the blocking member mounted to the latch housing 22 adjacent to the pawl 34 and also coupled to the actuation member 64, a position of the actuation member 64 controlled by the actuation signal to move the blocking member 50 between the unblocked position representing disengagement of the blocking member 50 with the pawl 34 and the blocked position representing the engagement with the pawl 34. For example, a solenoid 52 of the electronically actuated blocking system 49 can control positioning of the actuation member 64 via the actuation signal. Alternatively, as shown in FIG. 9, the blocking component 50 is the actuation member 64, a position of the actuation member 64 controlled by the actuation signal to move the actuation member 64 between the unblocked position representing direct disengagement of the blocking member 50 with the pawl 34 and the blocked position representing the engagement directly with the pawl 34. As such, the solenoid 52 of the electronically actuated blocking system 49 can control positioning of the actuation member 64 via the actuation signal with respect to the direct engagement with the pawl 34.

Referring again to FIG. 3, shown by example is a relative spaced apart position between the blocking component 50 and the detent surface 62a, 62b providing for a spatial separation 61 between an engagement surface 60 of the blocking component 50 and a corresponding engagement surface 62a, 62b of the detent when the blocking component 50 is positioned to inhibit movement of the pawl 34 to the ratchet release position. The engagement surface 60 of the blocking component 50 and the corresponding engagement surface 62a, 62b of the detent can be configured to bridge the spatial separation 61 and contact one another only during a crash event due to premature movement of the pawl 34 when subjected to crash conditions. For example, the spatial separation 61 can be between a half mil and one mil in distance. It is also recognized that the surfaces 60, 62a, 62b can be in contact with one another when the blocking component is positioned in the blocked position.

As an alternative embodiment of the latch 20, the latch 20 for the closure panel 14 of the vehicle 10 can be configured as the latch housing 22; the ratchet 24 mounted to the latch housing 22 and movable between a closed position in which the ratchet 24 retains the striker 28 in the slot 23 and an open position in which the ratchet 24 releases the striker 28 from the slot 23; the pawl 34 mounted to the latch housing 22 and movable between a ratchet holding position in which the pawl 34 holds the ratchet 24 in the closed position and a ratchet release position in which the pawl 34 facilitates ratchet movement towards the open position; and the electronically actuated blocking system 49 having an actuated and non-actuated state, the electronically actuated blocking system 49 having the blocking component 50, such that when placed in the actuated state by receipt of an actuation signal causes the blocking component 50 to engage with at least one of the pawl 34 or the ratchet 24 to inhibit movement of the ratchet 24 to the open position; wherein the electronically actuated blocking system 49 is placed in the actuated state by the actuation signal representing an operative state of the vehicle 10 remaining under control of the vehicle driver.

As noted above, an advantage to using the blocking component 50 to restrict movement directly on at least one of the latch components (e.g. ratchet 24, pawl 34) is that the blocking component 50 will also act to hold the ratchet 24 or pawl 34 from moving (i.e. out of latch locked position) due to inertia activated forces experienced by the release chain components during a pre-crash or crash event, for example, in more directions depending on the direction of the inertial forces.

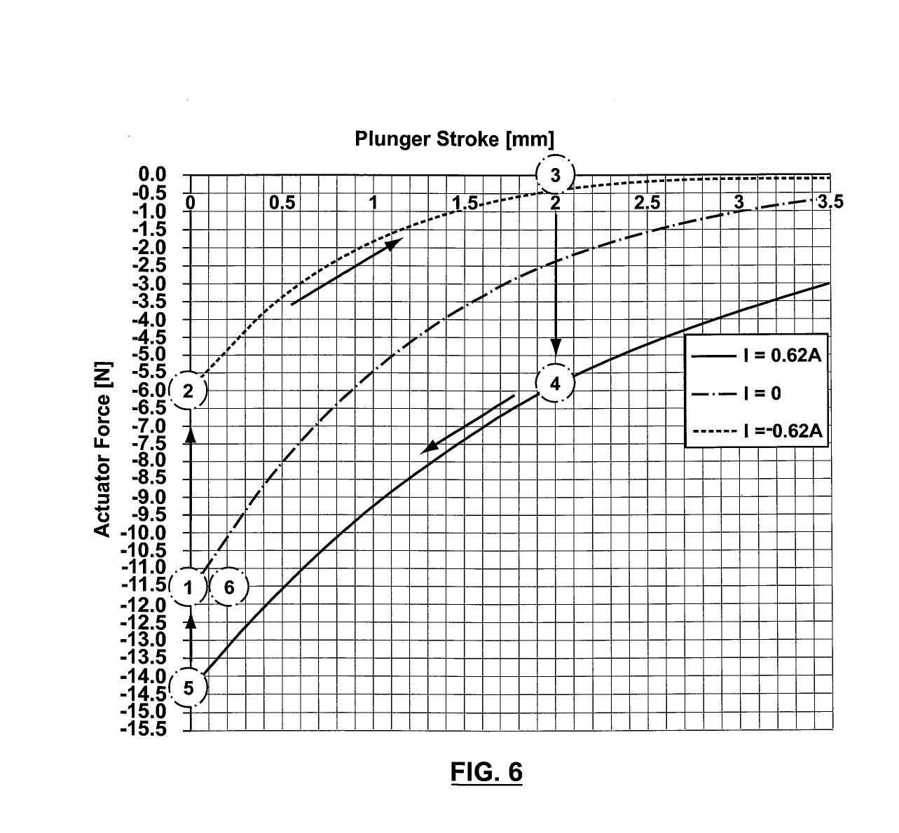

FIG. 6 shows the forces applied to the end member 64 through the range of movement thereof in a particular example. In position 1, the pawl blocking member 50 is engaged with the pawl 34 and there is no current applied to the solenoid. The position of the end member 64 is such that the attractive force applied by the magnet 52c is greater than the force exerted by the spring 52b. As a result, the end member 64 is stable in this position even though no power is being applied to the solenoid 52a. In the example shown, the force of the magnet 52c minus the spring force results in a net force of 11.5 N in the direction of retraction of the end member 64. The actual amounts may vary for different applications of the latch. When it is desired to extend the end member 64, a current is applied to the solenoid 52a which adds to the spring force in order to overcome the magnet force. This is shown as position 2 (which is the same physical position of the end member as position 2, but with a different net force being applied to the end member 64). As a result of the current, the end member 64 extends. The progressively increasing distance from the permanent magnet reduces the force applied thereby on the end member 64. Also, the increasing length of the spring 52b results in progressively less spring force on the end member 64. Once the end member 64 reaches the extended position (position 3) the current can be turned off and the spring force is sufficient to overcome the magnet force so as to hold the end member 64 in the extended position. In other words, the end member 64 is stable in the extended position with no power being applied to the solenoid 52a. When it is desired to retract the end member, an opposite current can be applied to the solenoid 52a so as to add to the magnet force in order to overcome the spring force, as represented by position 4. The new net force results in a retraction of the end member 64 towards the retracted position (position 5). Once the end member 64 reaches the retracted position, the current can be turned off and again the magnet force is sufficient to overcome the spring force so as to hold the end member 64 in the retracted position. The retracted and extended positions of the end member 64 may more broadly be termed first and second positions for the actuator 52. The values shown in FIG. 6 are examples only and are not intended to be limiting.

The blocking component 50 can act against the ratchet 24 and/or the pawl 34 in order to restrict movement of the striker 28 out of the slot 23 in the event of one or more components of the release chain 61 are called upon (e.g. manually by the occupant/driver and/or via the controller 54). For example, activation of the latch 20 with a release action by the occupant can be such as, but not limited to, pulling of the door handle 16, 17 or pressing of an door unlock button (e.g. processed via the control system 54) on either the interior or exterior of the vehicle 10.

It is also recognized that the blocking component 50 can act against other components of the release chain 61 other than the pawl 34, for example such as, but not limited to, the force member 67 (e.g. a rod and/or cable) used to transfer actuation of the handle 16, 17 to operation of the latch 20 (e.g. to cause the pawl 34 to be displaced from its latch position) and thus providing for the ratchet biasing member 30 to rotate the ratchet 24 and cause the striker 28 to be released from the slot 23 as the door 14 is moved into the open position (see FIG. 3). As such the blocking component 50 can be used to block movement of the force member 67 from actuating the latch 20, under control of the control system 54. The control system 54 controls movement of the blocking component 50 into the blocking position with respect to the force member 67, and also controls movement of the blocking component 50 away from the blocking position to provide for normal operation of the force member 67 with respect to the handle 16, 17.

It is also recognized that the blocking component 50 can act against other components of the release chain 61 other than the pawl 34, for example such as, but not limited to the electrical door latch 20 with the electric motor 69, which is electrically connected to a main electric power supply of the vehicle 10 (for example to the 12V battery of the same vehicle), in order to directly or indirectly drive the pawl 34, via an electrically-operated actuator coupled to the electric motor 69. As such, the blocking component 50 can be moved into the blocking position to block/inhibit operation of the electric motor 69 and/or the associated electrically-operated actuator, such that displacement of the pawl 34 out of the latched position (i.e. which would allow the ratchet to rotate for moving the striker 28 out of the slot 23) would be inhibited by the blocking component 50, under control of the control system 54. The control system 54 controls movement of the blocking component 50 into the blocking position with respect to the electrically-operated actuator and/or the electric motor 69, and also controls movement of the blocking component 50 away from the blocking position to provide for normal operation of the electrically-operated actuator and/or the electric motor 69.

It is also recognized that the blocking component 50 can act against other components of the release chain 61 other than the pawl 34, for example such as but not limited to the handle 16, 17. As such, the blocking component 50 can be moved into the blocking position to block/inhibit operation of the handle 16, 17, such that displacement of the pawl 34 out of the latched position under influence of handle 16, 17 operation would be inhibited by the blocking component 50, under control of the control system 54. The control system 54 controls movement of the blocking component 50 into the blocking position with respect to operation of the handle 16, 17, and also controls movement of the blocking component 50 away from the blocking position to provide for normal operation of the handle 16, 17.

Accordingly, it is recognized that any component of the release chain 61 that can influence inertial loading from any coupled components, from the door handles 16, 17 right up to the ratchet 24 that can affect the release of the latch 20 (e.g. cause the striker 28 to be released from the slot 23), can be acted upon by the blocking component 50 (or multiple blocking components 50) in order to block/inhibit their operation while under control of the control system 54 via positioning of the blocking component 50 in the blocking position. Examples of the blocking component 50 can be the pivotal lever 50 (see FIG. 3) and/or the actuator end 64 (see FIGS. 3 and 4).

Referring again to FIG. 4, in the event of a power failure from another source of power (e.g. the vehicle's 12V battery 400), an energy storage device 57 may be provided. The energy storage device 57 can provide power for the operation of the control system 54 and the solenoid 52a. The energy storage device 57 may by any suitable type of storage device, such as a battery, a capacitor, or a supercapacitor. The control system 54 may be programmed to draw power from the energy storage device 57 to operate the pawl blocking actuator to move the pawl blocking component 50 to the pawl blocking and open positions at least in the event of a power failure of the other power sources onboard the vehicle (e.g. the 12V battery 400). In some embodiments, the control system 54 may always draw power from the storage device 57 and the storage device 57 may be recharged from the 12V battery 400. In other embodiments, the control system 54 may typically draw power directly from the 12V battery 400 and will only draw power from the storage device 57 in the event of a power failure of the 12V battery 400. The energy stored in the storage device 57 may be selected to be suitable to provide power to the control system 54 for a selected period of time and to provide power to disengage the pawl blocking member 50 from the pawl 34 once that action is requested by the control system 54. By selecting the spring rate and the amount of compression in the biasing member 52b, the energy needed from the energy storage device 57 can be kept below selected levels.

The control system 54 may be used to control and/or receive signals from a plurality of components in the vehicle 10 and to control the operation of the pawl blocking actuator 50 according to any suitable algorithm or logic. The control system 54 may include a microprocessor 54a and a memory 54b coupled to the microprocessor 54a, as is known in the art. Alternatively, the control system 54 may be a complex distributed control system having multiple individual controllers each having a processor and memory, and which are connected to one another over a controller area network.

According to one embodiment, the control system 54 may be mounted in the door 14 proximate to the latch 20 or in the latch housing 22. According to another embodiment, the control system 54 may be mounted in the body 12 of the vehicle 10. According to one embodiment, the control system 54 may be included in the vehicle's main control unit (e.g., BCU). According to another embodiment, the control system 54 may be separate from the vehicle's main control unit (e.g., BCU). According to one embodiment, the control system 54 may be mounted in the latch housing 22 and the speed sensor 68f (see below) and/or other sensors 68 (see below) may be directly coupled to the control system 54. According to another embodiment, the control system 54 may be mounted in the latch housing 22, the speed sensor 68f and/or other sensors 68 may be coupled to the vehicle's main control unit (e.g., BCU), and the vehicle's main control unit may relay, transmit, or couple the output or data from the speed sensor 68f and/or other sensors 68 to the control system 54.

According to one embodiment, the control system 54 includes a microprocessor or central processing unit (“CPU”) 54a, memory 54b, and an interface device 450. The memory 54b may include a variety of storage devices including internal memory and external mass storage typically arranged in a hierarchy of storage as understood by those skilled in the art. For example, the memory 54b may include databases, random access memory (“RAM”), read-only memory (“ROM”), flash memory, and/or disk devices. The interface device 450 may include one or more network connections. The control system 54 may be adapted for communicating with other data processing systems (e.g., similar to the control system 54) over a network 451 via the interface device 450. For example, the interface device 450 may include an interface to a network 451 such as a local area network (“LAN”), etc. As such, the interface 450 may include suitable transmitters, receivers, etc. Thus, the control system 54 may be linked to other data processing systems by the network 451. The microprocessor 54a may include or be operatively coupled to dedicated coprocessors, memory devices, or other hardware modules 421. The microprocessor 54a is operatively coupled to the memory 54b which stores an operating system (e.g., 431) for general management of the control system 54. The control system 54 may include a data store or database system 432 for storing data and programming information. The database system 432 may include a database management system (e.g., 432) and a database (e.g., 432) and may be stored in the memory 54b of the control system 54. In general, the control system 54 has stored therein data representing sequences of instructions which when executed cause the method described herein to be performed. Of course, the control system 54 may contain additional software and hardware a description of which is not necessary for understanding the disclosure.

Thus, the control system 54 includes computer executable programmed instructions for directing the control system 54 to implement the embodiments of the present disclosure. The programmed instructions may be embodied in one or more hardware modules 421 or software modules 431 resident in the memory 54b of the control system 54 or elsewhere (e.g., 54a). Alternatively, the programmed instructions may be embodied on a computer readable medium or product (e.g., a memory stick, etc.) which may be used for transporting the programmed instructions to the memory 54b of the controller 54. Alternatively, the programmed instructions may be embedded in a computer-readable signal or signal-bearing medium or product that is uploaded to a network 451 by a vendor or supplier of the programmed instructions, and this signal or signal-bearing medium may be downloaded through an interface (e.g., 450) to the control system 54 from the network 451 by end users or potential buyers.

The control system 54 may be programmed to operate the pawl blocking actuator 52 as follows. In general, the control system 54 may be programmed to block the pawl 34 during operation of the vehicle 10 under typical driving conditions and not just when a crash event is imminent.

By blocking the pawl 34 during normal operation of the vehicle 10, the control system 54 may be tasked with determining when a vehicle occupant desires to exit the vehicle and then stopping blockage of the pawl 34. For this purpose, the control system 54 may receive signals from one or more of the following sensors as shown in FIG. 4: a seatbelt sensor 68a, a seat pressure sensor 68b, a transmission sensor 68c, an ignition sensor 68d, an airbag sensor 68e, a speed sensor 68f, a latch lock sensor 68g, a primary door ajar sensor 68h, a secondary door ajar sensor 68i, a crash sensor 68j, and a tachometer sensor 68k.

In general, the seatbelt sensor 68a may be used as an indicator of an occupant's desire to exit the vehicle. For example, if the control system 54 receives signals that the seatbelt was buckled and then receives a signal indicating that the seatbelt was removed, then the control system 54 may, in at least some cases, interpret the seatbelt removal as an indication that that occupant wishes to exit the vehicle. It will be noted that the control system's determination is on a seat by seat basis. For example, if a passenger removes his/her seatbelt but the driver keeps his/her seatbelt buckled, the control system 54 may optionally only disengage the pawl blocking component 50 for the passenger, while leaving the driver's pawl blocking component 50 in place in the pawl blocking position.

The control system 54 may be programmed to operate the pawl blocking actuator 52 to move the pawl blocking component 50 between the pawl blocking and open positions based in part on whether or not a vehicle occupant is detected in a seat proximate the particular door 14 in question. Seat pressure sensors 68b provide a way for the control system 54 to determine if an occupant is in a particular seat of the vehicle 10. For any unoccupied seats, the control system 54 may be configured to keep the pawl blocking component 50 in the open position. For any seats that are occupied, the control system 54 may move the pawl blocking component 50 to the pawl blocking position, depending on other criteria (such as, for example, vehicle speed). Other means for determining whether or not a seat is occupied by someone, such as, a camera system in the vehicle's passenger compartment, may be used.

A transmission sensor 68c may be used to determine whether the vehicle is in “Park” or if it is in “Drive” or in a gear.

An ignition sensor 68d may be used to determine whether the engine is on or not or whether a key is in the ignition or not.

An airbag sensor 68e may be used to determine whether a crash event is taking place or to assist with such determination. The control system 54 may use this information to determine an appropriate moment to disengage the pawl blocking component 50 from the pawl 34 so as to permit vehicle occupants to exit the vehicle (or to permit emergency personnel to enter the vehicle) after a crash has occurred.

A speed sensor 68f may be used to determine whether or not the vehicle 10 is moving, the speed at which the vehicle 10 is travelling, and/or the wheel speed of the vehicle 10. The control system 54, in some embodiments, determines whether the vehicle 10 is being operated in which case the control system 54 blocks the pawl 34 (assuming, in some embodiments, that other conditions are met, such as whether or not an occupant is in the seat proximate the door 14 in question). A determination that the vehicle 10 is moving may mean a determination that the vehicle's speed is greater than some value, such as 5 kph, 10 kph, 20 kph, or any other suitable speed.

The latch lock sensor 68g, like the seatbelt sensor 68a, may also be used as an indicator of an occupant's desire to exit the vehicle 10. For example, if the control system 54 receives signals that the latch 20 was locked and then receives a signal indicating that the latch 20 was unlocked, then the control system 54 may, in at least some cases, interpret the unlocking of the latch as an indication that that occupant wishes to exit the vehicle. It will be noted that the control system's determination is on a seat by seat basis. For example, if a passenger unlocks her/her latch (e.g. using a double pull override mechanism or using the lock knob 18) but the driver keeps his/her latch 20 locked, the control system 54 may optionally only disengage the pawl blocking component 50 for the passenger, while leaving the driver's pawl blocking component 50 in place in the pawl blocking position.

A primary door ajar sensor 68h and a secondary door ajar sensor 68i may be used to indicate whether the door is ajar or not. Alternatively, a single door sensor 68h or 68i may be used.

A crash sensor 68j may be used to indicate whether a crash event has occurred for the vehicle 10.

A tachometer sensor 68k may be used to indicate the revolutions per minute (RPM) of the crankshaft, for example, of the vehicle 10.

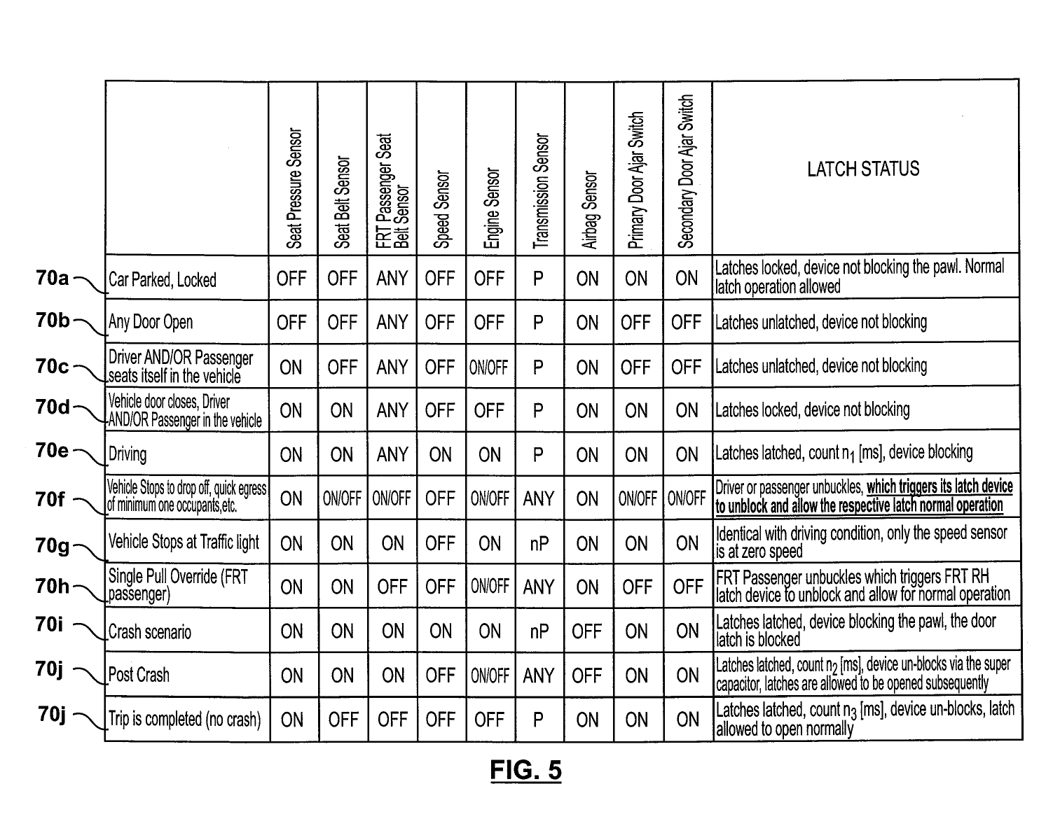

FIG. 5 is a table of sensor statuses and the resultant action by the control system 54 shown in FIG. 4. Example control system 54 responses to several sets of conditions relating to several specific situations will not be described with reference to a table of conditions shown in FIG. 5. The example in FIG. 5 determines whether the vehicle is being operated based primarily on seat pressure sensor 68b, seat belt sensor 68a, and speed sensor 68f indications, and includes exceptions for passenger ingress/egress. For the purposes of the table in FIG. 5, the sensors 68 may have the following states and corresponding meanings:

Seat Pressure Sensor 68b:

Off=the seat is unoccupied; On=the seat is occupied

Seatbelt Sensor 68a:

Off=the seatbelt is not buckled; On=the seatbelt is buckled

Speed Sensor 68f

Off=the vehicle is stationary; On=the vehicle is being driven

Ignition Sensor 68d

Off=the engine is off; On=the engine is on

Transmission Sensor 68c

P=park; R=reverse; N=neutral; D=drive; 1=1^{st} gear; 2=2^{nd} gear; etc

Airbag Sensor 68e

Off=the airbag has been deployed; On=the airbag has not been deployed

Door Ajar Sensor(s) 68h, 68i

Off=the door is open; On=the door is closed

A first set of conditions is shown at 70a and relates to a situation when the vehicle 10 is parked (and off), the door in question is locked, and there is no one in the seat proximate the door in question. Under these conditions the control system 54 maintains the pawl blocking component 50 in the open position so as to permit the door 14 to be opened, subject to the lock state of the latch 20, to permit a person to enter the vehicle 10. A second set of conditions is shown at 70b, and relates to when a person unlocks and opens the door 14 in order to enter the vehicle 10. Under these conditions, the control system 54 keeps the pawl blocking component 50 in the open position. A third set of conditions is shown at 70c, and relates to when a person sits in the seat after opening the door 14 and prior to closing the door 14. In such a situation, the pawl blocking component 50 remains in the open position. A fourth set of conditions shown at 70d relates to when the person is sitting in the seat and closes and locks the door 14. In such a situation, the pawl blocking component 50 is kept in the open position. Under conditions shown at 70e, when the engine is turned on and the vehicle is driven away, the control system 54 may count a selected number of milliseconds and may then operate the actuator 52 to place the pawl blocking component 50 in the pawl blocking position.

When the vehicle 10 stops at a stop light, as represented by conditions shown at 70f, the speed of the vehicle 10 drops to zero, however all other statuses of the other sensors remain the same as when the vehicle 10 was being driven. The control system 54 maintains the pawl blocking component 50 in the blocking position.

If the vehicle 10 arrives at a destination where a passenger will be dropped off, represented by conditions shown at 70g, the states of the sensors may be similar to the states of the sensors when the vehicle is stopped at a stoplight. However, when a passenger will be dropped off, the passenger will at some point unbuckle their seatbelt and will at some point unlock the door latch, assuming that their belt was buckled and the door latch was locked (the use of automatic door locks and seat belt warning systems is advantageous in association with the system described herein). The control system 54 may be configured to receive signals from one or both of the door latch lock sensor 68g and the seatbelt sensor 68a and to determine whether either sensor indicates a change from one state (i.e. the locked state for the latch lock sensor, or the buckled state for the seatbelt sensor) to the other state (i.e. the unlocked state, or the unbuckled state) while the vehicle 10 is stopped or within a selected amount of time prior to the stopping of the vehicle 10. Upon determining that there has been a change in state of one or both sensors 68a and 68g, the control system 54 may move the pawl blocking component 50 to the open position to permit the passenger to exit the vehicle 10.

As described in FIG. 5 at conditions 70h, in the event of a crash the vehicle door is latched and blocked.

The control system 54 may be programmed to unblock the pawl 34 after a crash event, as represented by conditions 70i, so as to permit occupants to exit the vehicle 10 and to permit emergency personnel to enter the vehicle 10 once the event is over. Unblocking the pawl 34 may take place after a selected time period has been determined to have elapsed since the crash event was first detected, or since the crash event is determined to have ended, or according to any other suitable logic.

Other situations (e.g. conditions at 70j) may also have specific positions of the pawl blocking component 50 associated with them.

According to one embodiment, a method of operating a latch (e.g. latch 20) for a door (e.g. door 14) for a vehicle (e.g. vehicle 10) is provided, comprising: a) using a pawl to hold a ratchet in a closed position to retain a striker so as to hold the door closed; b) determining whether the vehicle is being driven beyond a selected speed; and, c) blocking the pawl to prevent the pawl from moving to a position to release the ratchet based at least in part on the determination made in step b). Optionally, step c) comprises blocking the pawl to prevent the pawl from moving to a position to release the ratchet further based on a vehicle occupant being present in a seat proximate the door.

It will be noted that all of the above described functionality can be achieved using sensors such as sensors 68a-68k which are already present in the vehicle 10, and whose statuses can be accessed via any suitable means such as by a car area network (CAN) bus (e.g. 451).

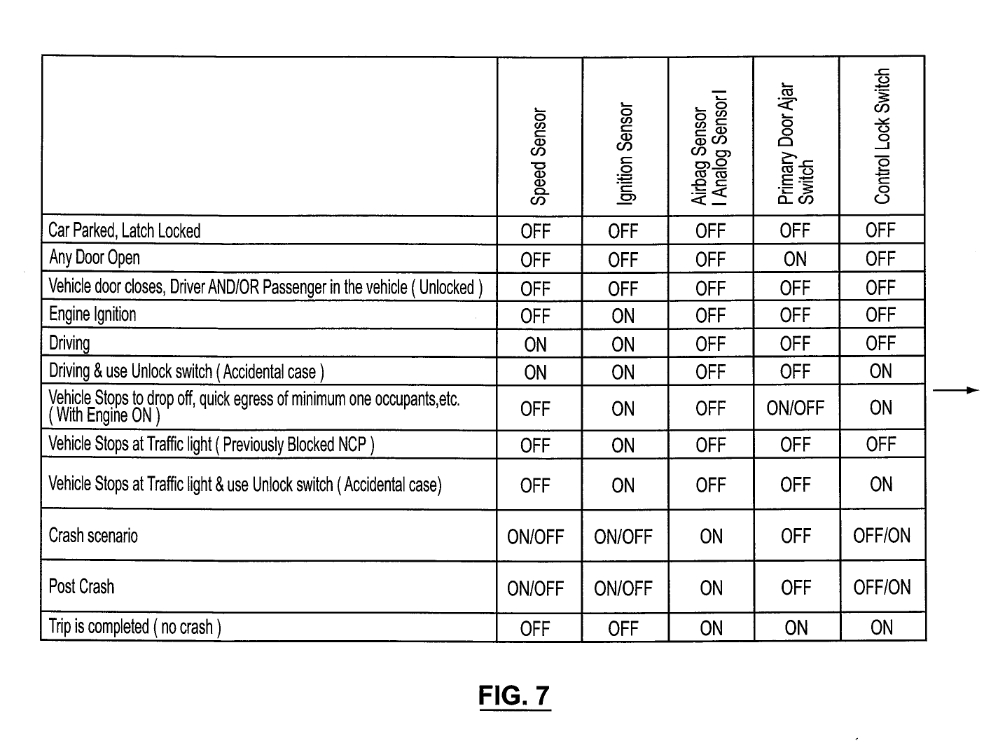

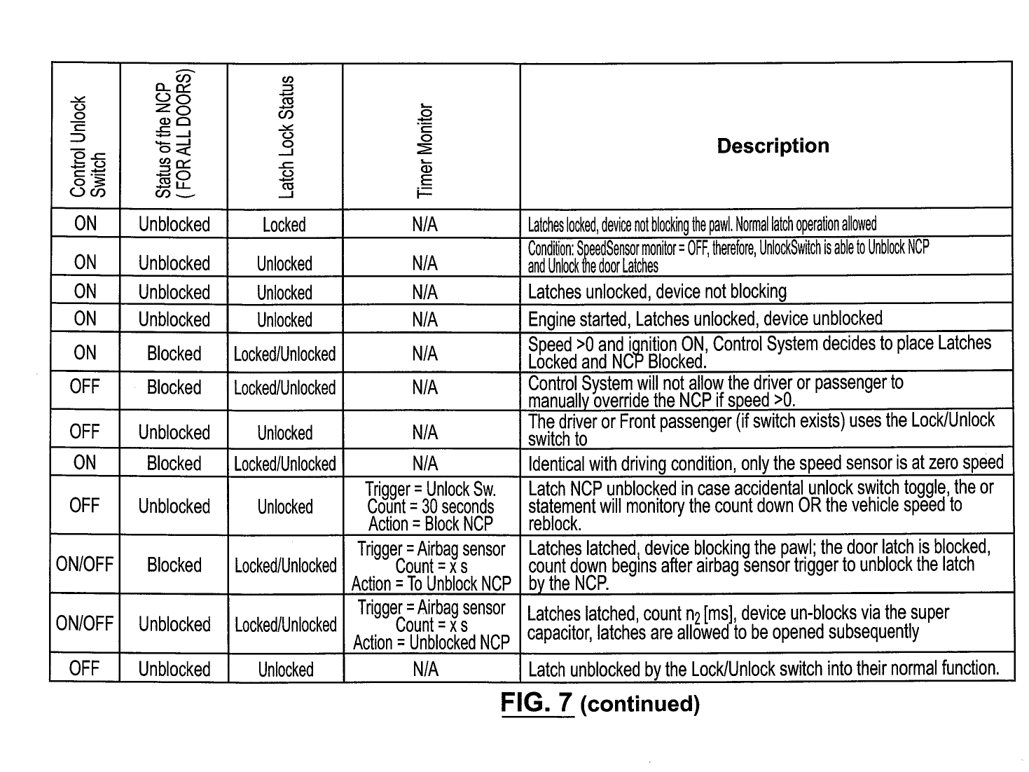

FIG. 7 is an alternative table of sensor statuses and the resultant action by the control system 54 shown in FIG. 4. An alternative latch system is described in the table of FIG. 7 for determining operation of the vehicle 10 based primarily on ignition sensor 68d, airbag sensor 68e, and speed sensor 68f indications of the vehicle 10, while allowing passenger ingress/egress based on the vehicle's central lock/unlock controls.

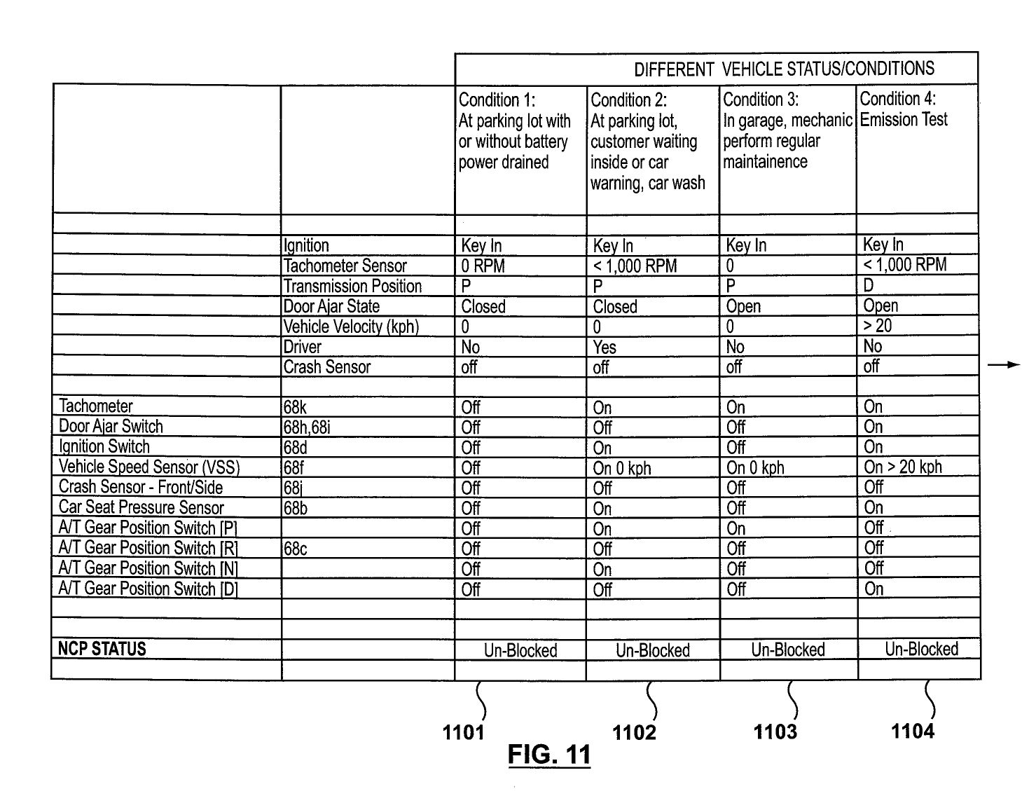

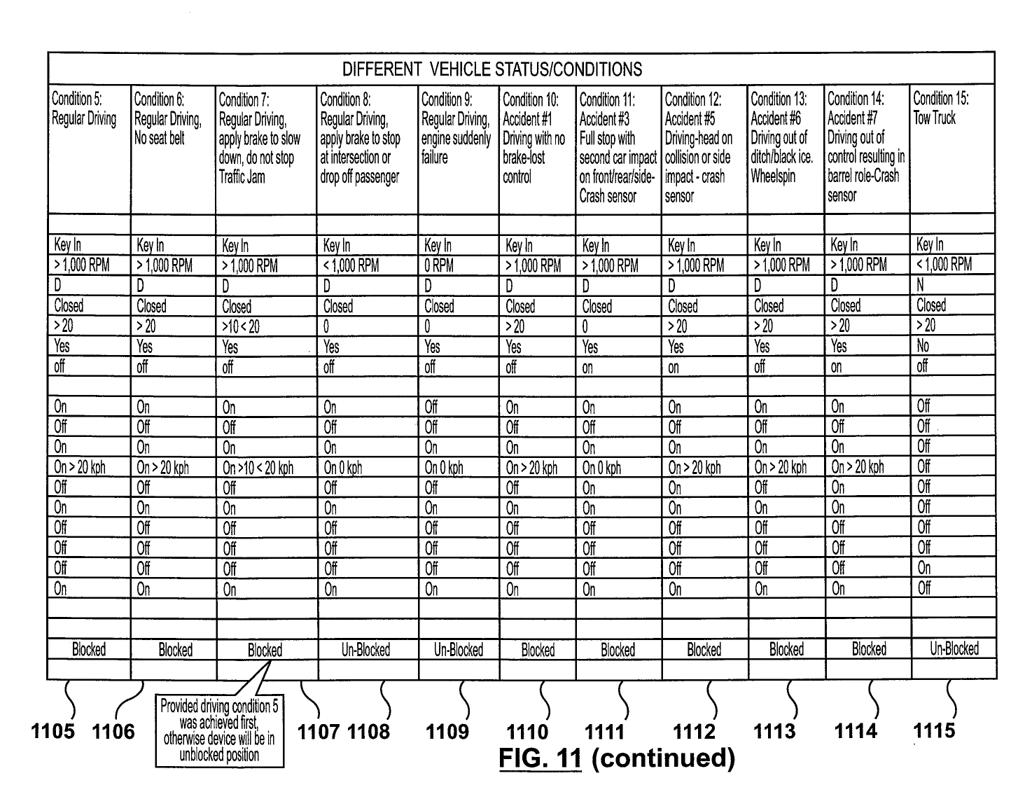

FIG. 11 is another alternative table of sensor statuses and the resultant action by the control system 54 shown in FIG. 4. FIG. 11 illustrates example control system 54 responses to specific conditions 1101-1115. In addition to the sensors 68 discussed above with respect to FIG. 5, at least some of the conditions 1101-1115 listed in FIG. 11 make use of the speed sensor 68f, crash sensor 68j, and tachometer sensor 68k. These additional sensors 68 may have the following states and corresponding meanings or additional meanings:

Speed Sensor 68k:

Off=speed is zero; On=speed >0 or speed <10 km/h or speed >20 kph or speed is between 10 kph and 20 kph

Crash Sensor 68i:

Off=crash event has not occurred; On=crash event has occurred

Tachometer Sensor 68k:

Off=RPM is zero; On=RPM <1000 RPM or >1000 RPM

For Condition 1 1101 in FIG. 11, the vehicle 10 may be in a parking lot with or without battery power drained. The ignition sensor 68d indicates that the key is out of the ignition, the tachometer sensor 68k indicates 0 RPM, the transmission sensor 68c indicates that the vehicle is in park (P), the door ajar sensor 68h indicates that the door 14 is closed, the speed sensor 68j indicates 0 kph, the car seat pressure sensor 68b indicates that the driver is not present, and the crash sensor 68j indicates that a crash event has not occurred. Under these conditions, the blocking component 50 is disengaged or deactivated to allow release of the latch 20. For example, the control system 54 may send a signal to the pawl blocking actuator 52 to operate and move the blocking component 50 out of blocking engagement with the pawl 34. In other words, the latch 20 is unblocked.

For Condition 2 1102 in FIG. 11, the vehicle 10 may be in a parking lot with the driver waiting inside or the vehicle 10 may be warming up or the vehicle 10 may be at a car wash. The ignition sensor 68d indicates that the key is in the ignition, the tachometer sensor 68k indicates <1000 RPM, the transmission sensor 68c indicates that the vehicle 10 is in park (P), the door ajar sensor 68h indicates that the door 14 is closed, the speed sensor 68j indicates 0 kph, the car seat pressure sensor 68b indicates that the driver is present, and the crash sensor 68j indicates that a crash event has not occurred. Under these conditions, the latch 20 is unblocked.

For Condition 3 1103 in FIG. 11, the vehicle 10 may be in a garage where a mechanic may be performing regular maintenance on the vehicle 10. The ignition sensor 68d indicates that the key is in the ignition, the tachometer sensor 68k indicates 0 RPM, the transmission sensor 68c indicates that the vehicle 10 is in park (P), the door ajar sensor 68h indicates that the door 14 is open, the speed sensor 68j indicates 0 kph, the car seat pressure sensor 68b indicates that the driver is not present, and the crash sensor 68j indicates that a crash event has not occurred. Under these conditions, the latch 20 is unblocked.

For Condition 4 1104 in FIG. 11, the vehicle 10 may be having an emission test. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is open, the speed sensor 68j indicates >20 kph, the car seat pressure sensor 68b indicates that the driver is not present, and the crash sensor 68j indicates that a crash event has not occurred. Under these conditions, the latch 20 is unblocked.

For Condition 5 1105 in FIG. 11, the vehicle 10 may be driving in a regular manner. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has not occurred. Under these conditions, the blocking component 50 is engaged or activated to block release of the latch 20. For example, the control system 54 may send a signal to the pawl blocking actuator 52 to operate and move the blocking component 50 in to blocking engagement with the pawl 34. In other words, the latch 20 is blocked.

For Condition 6 1106 in FIG. 11, the vehicle 10 may be driving in a regular manner but the driver may not be wearing his or her seatbelt. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has not occurred. Under these conditions, the latch 20 is blocked.

For Condition 7 1107 in FIG. 11, the vehicle 10 may be driving in a regular manner, the driver may have applied the brakes to slow the vehicle down, but the vehicle has not yet stopped. For example, the vehicle 10 may be in a traffic jam. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >10 kph and <20 kph, the car seat pressure sensor 68b indicates that the driver is present, and the crash sensor 68j indicates that a crash event has not occurred. Under these conditions, the latch 20 is blocked. Not that Condition 7 1107 assumes that Condition 5 1105 was achieved first, otherwise the latch 20 is unblocked.

For Condition 8 1108 in FIG. 11, the vehicle 10 may be driving in a regular manner and the driver may have applied the brakes to stop the vehicle 10 at an intersection or to drop off a passenger. The ignition sensor 68d indicates that the key is in the ignition, the tachometer sensor 68k indicates <1000 RPM, the transmission sensor 68c indicates that the vehicle 10 is in drive (D), the door ajar sensor 68h indicates that the door 14 is closed, the speed sensor 68j indicates 0 kph, the car seat pressure sensor 68b indicates that the driver is present, and the crash sensor 68j indicates that a crash event has not occurred. Under these conditions, the latch 20 is unblocked.

For Condition 9 1109 in FIG. 11, the vehicle 10 may be driving in a regular manner and a sudden engine failure may have occurred. The ignition sensor 68d indicates that the key is in the ignition, the tachometer sensor 68k indicates 0 RPM, the transmission sensor 68c indicates that the vehicle 10 is in drive (D), the door ajar sensor 68h indicates that the door 14 is closed, the speed sensor 68l indicates 0 kph, the car seat pressure sensor 68b indicates that the driver is present, and the crash sensor 68j indicates that a crash event has not occurred. Under these conditions, the latch 20 is unblocked.

For Condition 10 1110 in FIG. 11, the vehicle 10 may be in an accident, driving with no brake applied, or control may have been lost. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has not occurred. Under these conditions, the latch 20 is blocked.

For Condition 11 1111 in FIG. 11, the vehicle 10 may be in an accident in which the vehicle 10 has come to a full stop with second vehicle impact on the front/rear/side as indicated by the crash sensor 68j. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates 0 kph, the car seat pressure sensor 68b indicates that the driver is present, and the crash sensor 68j indicates that a crash event has occurred. Under these conditions, the latch 20 is blocked.

For Condition 12 1112 in FIG. 11, the vehicle 10 may be in an accident in which the vehicle 10 has experienced a head-on collision or side impact as indicated by the crash sensor 68j. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has occurred. Under these conditions, the latch 20 is blocked.

For Condition 13 1113 in FIG. 11, the vehicle 10 may have been in an accident and is now driving out of a ditch or the vehicle is driving on black ice and there may be wheel spin. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has not occurred. Under these conditions, the latch 20 is blocked.

For Condition 14 1114 in FIG. 11, the vehicle 10 may be in an accident in which the vehicle 10 is driving out of control resulting in a barrel roll as indicated by the crash sensor 68j. The ignition sensor 68d indicates that the key is in the ignition, the tachometer sensor 68k indicates >1000 RPM, the transmission sensor 68c indicates that the vehicle 10 is in drive (D), the door ajar sensor 68h indicates that the door 14 is closed, the speed sensor 68j indicates >20 kph, the car seat pressure sensor 68b indicates that the driver is present, and the crash sensor 68j indicates that a crash event has occurred. Under these conditions, the latch 20 is blocked.

For Condition 15 1115 in FIG. 11, the vehicle 10 may be being towed by a tow truck. The ignition sensor 68d indicates that the key is in the ignition, the tachometer sensor 68k indicates <1000 RPM, the transmission sensor 68c indicates that the vehicle 10 is in neutral (N), the door ajar sensor 68h indicates that the door 14 is closed, the speed sensor 68j indicates >20 kph, the car seat pressure sensor 68b indicates that the driver is not present, and the crash sensor 68j indicates that a crash event has not occurred. Under these conditions, the latch 20 is unblocked.

According to one embodiment, detection of an occupant in a seat of the vehicle 10, as described above with reference to FIG. 11 and in FIG. 11, is optional.

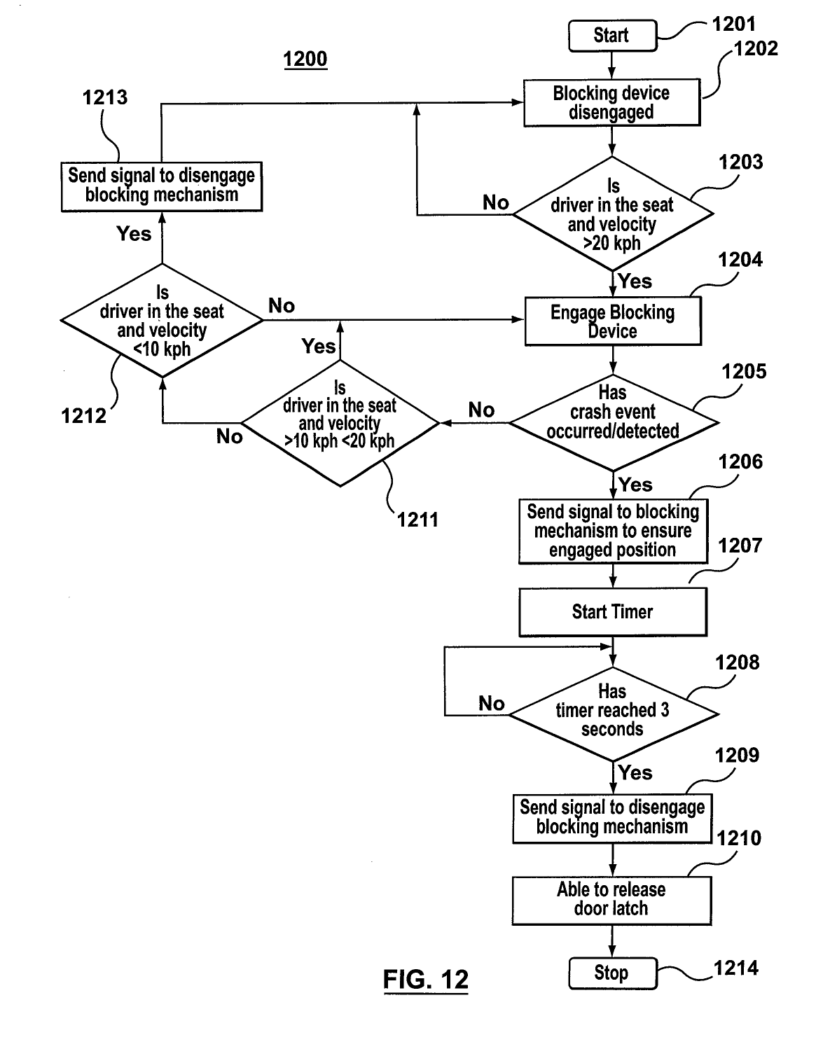

FIG. 12 is a flowchart flow chart illustrating operations 1200 of modules (e.g., software or hardware modules 431, 421) within a control system 54 for controlling a blocking component 50 for a latch 20 of a closure panel 14 of a vehicle 10.

At step 1201, the operations 1200 start.

At step 1202, the blocking component 50 is disengaged or deactivated to allow release of the latch 20. For example, the control system 54 may send a signal to the pawl blocking actuator 52 to operate and move the blocking component 50 out of blocking engagement with the pawl 34.

At step 1203, a determination is made as to whether a driver or occupant is in a seat of the vehicle 10 and whether the velocity or speed of the vehicle 10 is greater than 20 kph (approximately). If an occupant is in a seat of the vehicle 10 and the speed of the vehicle is greater than 20 kph, then operations continue to step 1204. Otherwise, if an occupant is not in a seat of the vehicle 10 and/or the speed of the vehicle is less than 20 kph, then operations return to step 1202.

At step 1204, the blocking component 50 is activated to block release of the latch 20 and operations continue to step 1205.

At step 1205, a determination is made as to whether a crash event has occurred or has been detected. If a crash event has occurred, then operations continue to step 1206. If a crash event has not occurred, then operations continue to step 1211.

At step 1206, the blocking component 50 is activated to block release of the latch 20 and operations continue to step 1207.

At step 1207, a timer is started and operations continue to step 1208. The timer may be implemented by a software or hardware module 431, 421 within the control system 54.

At step 1208, a determination is made as to whether the timer has reached a predetermined period of time, for example, 3 seconds. If the timer has reached the predetermined period of time, operations continue to step 1209. Otherwise, if the timer has not reached the predetermined period of time, then operations return to step 1208.

At step 1209, the blocking component 50 is deactivated to allow release of the latch 20 and operations continue to step 1210.

At step 1210, the blocking component 50 having been deactivated, the latch 20 may be released and operations continue to step 1214.

At step 1211, a determination is made as to whether a driver or occupant is in a seat of the vehicle 10 and whether the velocity or speed of the vehicle 10 is between 10 kph (approximately) and 20 kph (approximately). If an occupant is in a seat of the vehicle 10 and the speed of the vehicle is between 10 kph and 20 kph, then operations return to step 1204. Otherwise, if an occupant is not in a seat of the vehicle 10 and/or the speed of the vehicle is not between 10 kph and 20 kph, then operations continue to step 1212.

At step 1212, a determination is made as to whether a driver or occupant is in a seat of the vehicle 10 and whether the velocity or speed of the vehicle 10 is less than 10 kph (approximately). If an occupant is in a seat of the vehicle 10 and the speed of the vehicle is less than 10 kph, then operations continue to step 1213. Otherwise, if an occupant is not in a seat of the vehicle 10 and/or the speed of the vehicle is not less than 10 kph, then operations return to step 1204.

At step 1213, the blocking component 50 is deactivated to allow release of the latch 20 and operations return to step 1202.

At step 1214, the operations 1200 end.

According to one embodiment, detection of an occupant in a seat of the vehicle 10, as described above with reference to FIG. 12 and in FIG. 12, is optional.

Thus, according to one embodiment, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; and, blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open, wherein the blocking position is adjacent either the ratchet or the pawl, and restricts movement of the ratchet or pawl, respectively.

According to one embodiment, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open; and, when the vehicle speed is below a second threshold, automatically without occupant intervention, positioning the blocking component into a non-blocking position away from the at least one of the latch components to allow movement of the at least one of the latch components which movement would cause the latch to open.

According to one embodiment, there is provided a method comprising: determining if wheel speed (or speed) of a vehicle is above a first threshold; and, blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open; and disallowing vehicle occupant positioning of the blocking component.

According to one embodiment, there is provided a method comprising: determining if wheel speed (or speed) of a vehicle is above a first threshold; blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open; and, when the wheel speed is below a second threshold, automatically without occupant intervention, positioning the blocking component into a non-blocking position away from the at least one latch component to allow movement of the at least one latch component which movement would cause the latch to open.

According to one embodiment, there is provided a method comprising: determining if wheel speed (or speed) of a vehicle is above a first threshold; and, blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open, wherein the blocking position is adjacent either a ratchet having a striker capture position and a striker release position or a pawl of the latch, and restricts movement of the ratchet or pawl, respectively.

According to one embodiment, there is provided a method comprising: determining if wheel speed (or speed) of a vehicle is above a first threshold; and, blocking release of a latch of a closure panel of the vehicle by positioning a blocking component of the latch when the wheel speed is above the first threshold, automatically without vehicle occupant intervention and independently of a lock mechanism of the latch, into a blocking position adjacent to at least one latch component of the latch, to restrict movement of the at least one latch component which movement would cause the latch to open.

According to one embodiment, there is provided a method comprising: blocking release of a latch of a closure panel of a vehicle by positioning a blocking component of the latch, automatically without vehicle occupant intervention, into a blocking position adjacent to at least one latch component of the latch, to restrict movement of the at least one latch component which movement would cause the latch to open, wherein the blocking component is positionable in a first position corresponding to an unblocked position for the blocking component, and a second position corresponding to the blocked position for the blocking component, and the blocking component is stable in both the first and second positions without energization in order to maintain the blocking component in either of the unblocked or blocked positions.

According to one embodiment, there is provided a method for controlling a blocking component for a latch of a closure panel of a vehicle, the latch having latch components including a ratchet and pawl, the method comprising: determining whether an occupant is in the vehicle and whether a speed of the vehicle is above a first threshold; and, blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open.

In at least one of the above methods, a mechanism for effecting removal of the blocking component from the blocking position may be inaccessible to the occupant. The blocking component may be mechanically retained in the blocking position unless acted upon by a blocking actuator in order to remove the blocking component from the blocking position. A toggle switch may provide for said mechanically retained in the blocking position. The blocking actuator may be a solenoid actuator. And, the blocking component when in the blocking position may restrict the movement of the at least one of the latch components when the at least one of the latch components is subjected to inertial loading in a crash event.

According to one embodiment, there is provided a method for controlling a blocking component for a latch of a closure panel of a vehicle, comprising: determining whether an occupant is in the vehicle, whether a speed of the vehicle is above a first threshold, and whether a crash event has occurred; and, when the occupant is in the vehicle, the speed is above the first threshold, and the crash event has not occurred, activating the blocking component to block release of the latch.

According to one embodiment, there is provided a method for controlling a blocking component for a latch of a closure panel of a vehicle, comprising: determining whether an occupant is in the vehicle and whether a speed of the vehicle is above a first threshold; and, when the occupant is in the vehicle and the speed is above the first threshold, activating the blocking component to block release of the latch.

At least one of the above methods may further include: determining whether a crash event has occurred; when the crash event has not occurred, determining whether the occupant is in the vehicle and whether the speed has reduced to between the first threshold and a second threshold; and, when the occupant is in the vehicle and the speed has reduced to between the first threshold and the second threshold, activating the blocking component to block release of the latch.

At least one of the above methods may further include: when the crash event has not occurred, determining whether the occupant is in the vehicle and whether the speed has reduced to below the second threshold; and, when the occupant is in the vehicle and the speed has reduced to below the second threshold, deactivating the blocking component to allow release of the latch.

At least one of the above methods may further include: when the blocking component has been activated to block release of the latch, determining whether a crash event has occurred; and, when the crash event has occurred, confirming that the blocking component has been activated.

At least one of the above methods may further include: when the crash event has occurred and the activation of the blocking component has been confirmed, determining whether a predetermined period of time has elapsed; and, when the predetermined period of time has elapsed, deactivating the blocking component to allow release of the latch.

At least one of the above methods may further include: when the crash event has occurred, activating the blocking component to block release of the latch.

At least one of the above methods may further include: determining whether the closure panel is open; and, when the closure panel is open, deactivating the blocking component to allow release of the latch.

In at least one of the above methods, the blocking component may not be manually deactivated. The operation of the blocking component may be independent of operation of a lock of the closure panel. The blocking component may not be deactivated by the occupant unlocking the closure panel. The first threshold may be greater than the second threshold. The first threshold may be or may be approximately 20 kph. The second speed threshold may be or may be approximately 10 kph. The predetermined period of time may be or may be approximately three seconds. The occupant may be a driver of the vehicle. The determining whether the occupant is in the vehicle may include monitoring a pressure sensor in a seat of the vehicle. The determining whether the crash event has occurred may include monitoring a crash sensor in the vehicle. The crash event may include one or more of a pre-crash event and a post-crash event. The speed or wheel speed is determined by monitoring a speed sensor in the vehicle. The closure panel may be a door for the occupant to enter or exit the vehicle. The closure panel may be one or more closure panels. The determining may be performed by a processor. The processor may be included in a control system located in the vehicle. And, the processor may be included in a control system located in or proximate the closure panel or a housing for the latch.

According to one embodiment, there is provided a latch for a closure panel of a vehicle, the latch including: a latch housing; a ratchet mounted to the latch housing and movable between a closed position in which the ratchet retains a striker in a slot and an open position in which the ratchet releases the striker from the slot; a pawl mounted to the latch housing and movable between a ratchet holding position in which the pawl holds the ratchet in the closed position and a ratchet release position in which the pawl facilitates ratchet movement towards the open position; and an electronically actuated blocking system having an actuated and non-actuated state, the electronically actuated blocking system positioned with respect to the pawl and having a blocking component, such that when placed in the actuated state by receipt of an actuation signal causes the blocking component to move into position to engage with the pawl to inhibit movement of the pawl to the ratchet release position; wherein the electronically actuated blocking system is placed in the actuated state by the actuation signal representing an operative state of the vehicle remaining under control of a vehicle driver.

In the above latch, the actuation signal may be a sensor signal interpreted by a controller of the electronically actuated blocking system as representing the operative state based on matching the sensor signal to a sensor threshold. The actuation signal may be a switch signal sent by a vehicle controller separate from the electronically actuated blocking system, such that the vehicle controller generated the switch signal based on matching a sensor signal to a sensor threshold. The operative state may be opposite to a crash state representing at least one of a pre-crash event, a crash event, or a post crash event, such that the crash state represents an inoperative state of the vehicle as out of control of the vehicle driver. The blocking component may be positionable in a first position corresponding to an unblocked position for the blocking component, and a second position corresponding to a blocked position for the blocking component, such that the blocking component is stable in both the first and second positions without continued receipt of the actuation signal or other energization in order to maintain the blocking component in either of the unblocked or blocked positions. A multiple position biasing member may retain the blocking component in either the first position or the second position. The multiple position biasing member may be a toggle switch. The electronically actuated blocking system may include the blocking component contained within an interior of the latch housing. The blocking component may engage with the pawl within an interior of the latch housing through an aperture in an external wall of the latch housing. The blocking component may be a blocking member mounted to the latch housing adjacent to the pawl and also coupled to an actuation member, a position of the actuation member controlled by the actuation signal to move the blocking member between the unblocked position representing disengagement of the blocking member with the pawl and the blocked position representing the engagement with the pawl. The latch may further include a solenoid of the electronically actuated blocking system, such that the solenoid controls positioning of the actuation member via the actuation signal. The latch may further include a detent in the pawl for engagement by the blocking component to provide said inhibit movement of the pawl to the ratchet release position. A relative spaced apart position between the blocking component and the detent may provide for a spatial separation between an engagement surface of the blocking component and a corresponding engagement surface of the detent when the blocking component is positioned to said inhibit movement of the pawl to the ratchet release position. The engagement surface of the blocking component and the corresponding engagement surface of the detent may be configured to bridge the spatial separation and contact one another only during a crash event due to premature movement of the pawl. The spatial separation may be between a half millimeter (or mil) and one millimeter (or mil) in distance. The blocking component may be an actuation member, a position of the actuation member controlled by the actuation signal to move the actuation member between the unblocked position representing direct disengagement of the blocking member with the pawl and the blocked position representing the engagement directly with the pawl. And, the latch may further include a solenoid of the electronically actuated blocking system, such that the solenoid controls positioning of the actuation member via the actuation signal with respect to the direct engagement with the pawl.

According to one embodiment, there is provided a latch for a closure panel of a vehicle, the latch including: a latch housing; a ratchet mounted to the latch housing and movable between a closed position in which the ratchet retains a striker in a slot and an open position in which the ratchet releases the striker from the slot; a pawl mounted to the latch housing and movable between a ratchet holding position in which the pawl holds the ratchet in the closed position and a ratchet release position in which the pawl facilitates ratchet movement towards the open position; and an electronically actuated blocking system having an actuated and non-actuated state, the electronically actuated blocking system having a blocking component, such that when placed in the actuated state by receipt of an actuation signal causes the blocking component to engage with at least one of the pawl or the ratchet to inhibit movement of the ratchet to the open position; wherein the electronically actuated blocking system is placed in the actuated state by the actuation signal representing an operative state of the vehicle remaining under control of a vehicle driver.

In the above latch, the blocking component may be positionable in a first position corresponding to an unblocked position for the blocking component, and a second position corresponding to a blocked position for the blocking component, such that the blocking component is stable in both the first and second positions without continued receipt of the actuation signal in order to maintain the blocking component in either of the unblocked or blocked positions. And, the electronically actuated blocking system may include the blocking component contained within an interior of the latch housing.

According to one embodiment, there is provided a latch for use with a striker, the latch comprising: latch components further comprising a ratchet, a pawl, a release mechanism, a lock mechanism, and a blocking mechanism; wherein the blocking mechanism is independent of the lock mechanism to block movement of the ratchet or the pawl.

According to one embodiment, while the latch described herein in at least some embodiments includes a release lever, a lock link, a pawl blocking member and a pawl blocking actuator in addition to other mechanical components, it will be noted that the latch could alternatively have a largely electric actuation and could include a ratchet and pawl, and a motor for driving the pawl, such that the latch does not include a release lever, a lock link a pawl blocking member and a pawl blocking actuator. Such a latch could have a motor that drives a worm, which engages gear teeth directly on the pawl or alternatively engages the pawl via one or more intermediate gears. In such an instance a control system could control the operation of the motor so as to prevent movement of the pawl out of the ratchet holding position. Thus, a dedicated pawl blocking member is not required.

According to one embodiment, as discussed herein, a latch for a door for a vehicle, may include a ratchet movable between a closed position in which the ratchet is positioned to capture a striker and an open position in which the ratchet is positioned to release the striker, wherein the ratchet is biased towards the open position; a pawl movable between a ratchet holding position in which the pawl holds the ratchet in the closed position and a ratchet release position in which the pawl permits the ratchet to move to the open position; and a control system that is operatively connected to the pawl to prevent movement of the pawl to the ratchet release position based in part on a vehicle occupant being present in a seat proximate the door.

According to one embodiment, the latch may include a pawl blocking member that is movable between a pawl blocking position in which the pawl blocking member prevents the pawl from leaving the ratchet holding position and an open position in which the pawl blocking member permits movement of the pawl to the ratchet release position; and a pawl blocking actuator that is operable to move the pawl blocking member between the pawl blocking and open positions, wherein the control system operates the pawl blocking actuator to move the pawl blocking member to the open position based in part on whether or not a vehicle occupant is detected in a seat proximate the door.

According to one embodiment, the latch may include an energy storage device, wherein the control system draws power from the energy storage device to operate the pawl blocking actuator to move the pawl blocking member between the pawl blocking and open positions at least in the event of a power failure from another power source onboard the vehicle. The energy storage device may be a capacitor.

According to one embodiment, the control system may detect whether or not a vehicle occupant is in the seat proximate the door based on signals from a seat pressure sensor. The control system may detect whether or not a vehicle occupant is in a seat proximate the door based on signals from a seatbelt sensor.

According to one embodiment, the latch may include a release lever and a locking member, wherein the locking system is movable between a locked position wherein the locking member operatively connects the release lever with the pawl and an unlocked position wherein the locking member operatively connects the release lever with the pawl, and wherein the pawl blocking member is movable to the open position regardless of whether or not the locking member is in the locked position.

According to one embodiment, the control system may prevent movement of the pawl to the ratchet release position further based on whether the vehicle is being driven beyond a selected speed.

According to one embodiment, as discussed herein, a latch for a door for a vehicle, may include a ratchet movable between a closed position in which the ratchet is positioned to capture a striker and an open position in which the ratchet is positioned to release the striker, wherein the ratchet is biased towards the open position; a pawl movable between a ratchet holding position in which the pawl holds the ratchet in the closed position and a ratchet release position in which the pawl permits the ratchet to move to the open position; and a control system that is operatively connected to the pawl to prevent movement of the pawl to the ratchet release position based in part on a vehicle occupant being present in a seat proximate the door.

According to one embodiment, the pawl blocking actuator may be positionable in a first position corresponding to the open position for the pawl blocking member, and a second position corresponding to the pawl blocking position for the pawl blocking member, and wherein the pawl blocking actuator is stable in both the first and second positions without an input of power thereto.

According to one embodiment, the control system may position the pawl blocking member in the open position upon determining when a vehicle occupant in the seat proximate the door desires to exit the vehicle, and to position the pawl blocking member in the pawl blocking position upon detection of movement of the vehicle beyond a selected speed.

According to one embodiment, the selected speed may be less than about 20 kph

According to one embodiment, the control system may determine that a vehicle occupant in the seat proximate the door desires to exit the vehicle by detecting at least one of: the unbuckling of the seatbelt for the seat proximate the door and the unlocking of the door.

According to one embodiment, as a further example, a latch for a door for a vehicle may include a ratchet movable between a closed position in which the ratchet is positioned capture a striker and an open position in which the ratchet is positioned to release the striker, wherein the ratchet is biased towards the open position; a pawl movable between a ratchet holding position in which the pawl holds the ratchet in the closed position and a ratchet release position in which the pawl permits the ratchet to move to the open position; and a control system that is operatively connected to a pawl blocking member to determine whether the vehicle is being driven beyond a selected speed; and to block the pawl to prevent the pawl from moving to a position to release the ratchet based at least in part on the preceding determination.

According to one embodiment, the pawl blocking member may be movable between a pawl blocking position in which the pawl blocking member physically blocks the pawl from moving to the ratchet release position and an open position in which the pawl blocking member permits movement of the pawl to the ratchet release position, and wherein the latch further includes a pawl blocking actuator that is operable to move the pawl blocking member between the pawl blocking and open positions, wherein the control system is operatively connected to the pawl blocking actuator.

According to one embodiment, the latch may include an energy storage device, wherein the control system draws power from the energy storage device to operate the pawl blocking actuator to move the pawl blocking member to the open position. The energy storage device may be a capacitor.

According to one embodiment, the latch may include a release lever and a locking member, wherein the locking system is movable between a locked position wherein the locking member operatively connects the release lever with the pawl and an unlocked position wherein the locking member operatively connects the release lever with the pawl, and wherein the pawl blocking member is movable to the unblocked position regardless of whether or not the locking member is in the locked position.

According to one embodiment, the control system may block the pawl further based on a vehicle occupant being present in a seat proximate the door.

According to one embodiment, the latch may include a release lever and a locking member, wherein the locking system is movable between a locked position wherein the locking member operatively connects the release lever with the pawl and an unlocked position wherein the locking member operatively connects the release lever with the pawl, and wherein the pawl blocking member is movable to the open position regardless of whether or not the locking member is in the locked position.

According to one embodiment, the control system may prevent movement of the pawl to the ratchet release position further based on whether the vehicle is being driven beyond a selected speed.

According to one embodiment, the pawl blocking actuator may be positionable in a first position corresponding to the open position for the pawl blocking member, and a second position corresponding to the pawl blocking position for the pawl blocking member, and wherein the pawl blocking actuator is stable in both the first and second positions without an input of power thereto.

According to one embodiment, the preceding selected speed may be less than about 20 kph.

According to one embodiment, the control system may determine that a vehicle occupant in the seat proximate the door desires to exit the vehicle by detecting at least one of: the unbuckling of the seatbelt for the seat proximate the door and the unlocking of the door.

According to one embodiment, as another example, a latch for a door for a vehicle includes a ratchet movable between a closed position in which the ratchet is positioned capture a striker and an open position in which the ratchet is positioned to release the striker, wherein the ratchet is biased towards the open position; a pawl movable between a ratchet holding position in which the pawl holds the ratchet in the closed position and a ratchet release position in which the pawl permits the ratchet to move to the open position; and a pawl blocking member that is movable between a pawl blocking position in which the pawl blocking member prevents the pawl from leaving the ratchet holding position and an open position in which the pawl blocking member permits movement of the pawl to the ratchet release position; a pawl blocking actuator that is operable to move the pawl blocking member between the pawl blocking and open positions; and a control system that is operatively connected to the pawl blocking actuator, and to operate the pawl blocking actuator to move the pawl blocking member to the open position based in part on a vehicle occupant being present in a seat proximate the door, and on whether the vehicle is being driven beyond a selected speed.

According to one embodiment, as a different example, a method of operating a latch for a door for a vehicle, may include using a pawl to hold a ratchet in a closed position to retain a striker so as to hold the door closed; determining whether the vehicle is being driven beyond a selected speed; and blocking the pawl to prevent the pawl from moving to a position to release the ratchet based at least in part on the preceding determination.

According to one embodiment, blocking the pawl may include preventing the pawl from moving to a position to release the ratchet further based on a vehicle occupant being present in a seat proximate the door.

According to one embodiment, alternatively, a latch for a closure panel for a vehicle includes a ratchet, a pawl and a control system. The ratchet is movable between a closed position in which the ratchet is positioned to capture a striker and an open position in which the ratchet is positioned to release the striker, and may be biased towards the open position. The pawl is movable between a ratchet holding position in which the pawl holds the ratchet in the closed position and a ratchet release position in which the pawl permits the ratchet to move to the open position. The control system is operatively connected to the pawl and determines whether or not the vehicle is being operated based on a plurality of vehicle sensors and blocks the pawl to prevent the pawl from moving to a position to release the ratchet when the vehicle is being operated.

According to one embodiment, each of the above described method steps may be implemented by a respective software module 431. According to another embodiment, each of the above described method steps may be implemented by a respective hardware module 421. According to another embodiment, each of the above described method steps may be implemented by a combination of software and hardware modules 431, 421.

While aspects of this disclosure are primarily discussed as a method, a person of ordinary skill in the art will understand that the apparatus discussed above with reference to a control system 54 may be programmed to enable the practice of the method of the disclosure. Moreover, an article of manufacture for use with a control system 54, such as a pre-recorded storage device or other similar computer readable medium or computer program product including program instructions recorded thereon, may direct the control system 54 to facilitate the practice of the method of the disclosure. It is understood that such apparatus, products, and articles of manufacture also come within the scope of the disclosure.

In particular, the sequences of instructions which when executed cause the method described herein to be performed by the control system 54 may be contained in a data carrier product according to one embodiment of the invention. This data carrier product may be loaded into and run by the control system 54. In addition, the sequences of instructions which when executed cause the method described herein to be performed by the control system 54 may be contained in a computer software product or computer program product (e.g., comprising a non-transitory medium) according to one embodiment of the invention. This computer software product or computer program product may be loaded into and run by the control system 54. Moreover, the sequences of instructions which when executed cause the method described herein to be performed by the control system 54 may be contained in an integrated circuit product (e.g., a hardware module or modules 421) which may include a coprocessor or memory according to one embodiment of the disclosure. This integrated circuit product may be installed in the control system 54.

While the above description constitutes a plurality of embodiments, it will be appreciated that the present disclosure is susceptible to further modification and change without departing from the fair meaning of the accompanying claims.

We claim:

1. (canceled)

2. (canceled)

3. (canceled)

4. A method comprising:
determining if wheel speed of a vehicle is above a first threshold; and, blocking release of a latch of a closure panel of the vehicle by positioning a blocking component of the latch when the wheel speed is above the first threshold, automatically without vehicle occupant intervention and independently of a lock mechanism of the latch, into a blocking position adjacent to at least one latch component of the latch, to restrict movement of the at least one latch component which movement would cause the latch to open.

5. (canceled)

6. (canceled)

7. (canceled)

8. A method for controlling a blocking component for a latch of a closure panel of a vehicle, the latch having latch components including a ratchet and pawl, the method comprising:
determining whether an occupant is in the vehicle and whether a speed of the vehicle is above a first threshold; and,
blocking release of the latch by positioning the blocking component whenever the occupant is in the vehicle and the speed is above the first threshold, automatically without occupant intervention, into a blocking position adjacent to at least one of the latch components to restrict movement of the at least one of the latch components which movement would cause the latch to open.

9. (canceled)

10. The method of claim 4, wherein the blocking component is mechanically retained in the blocking position unless acted upon by a blocking actuator in order to remove the blocking component from the blocking position.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. The method of claim 4, wherein the blocking component cannot be manually deactivated.

23. The method of claim 4, wherein operation of the blocking component is independent of operation of a lock of the closure panel.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A latch for a closure panel of a vehicle, the latch including:
a latch housing;
a ratchet mounted to the latch housing and movable between a closed position in which the ratchet retains a striker in a slot and an open position in which the ratchet releases the striker from the slot;
a pawl mounted to the latch housing and movable between a ratchet holding position in which the pawl holds the ratchet in the closed position and a ratchet release position in which the pawl facilitates ratchet movement towards the open position; and
an electronically actuated blocking system having an actuated and non-actuated state, the electronically actuated blocking system positioned with respect to the pawl and having a blocking component, such that when placed in the actuated state by receipt of an actuation signal causes the blocking component to move into position to engage with the pawl to inhibit movement of the pawl to the ratchet release position;
wherein the electronically actuated blocking system is placed in the actuated state by the actuation signal representing an operative state of the vehicle remaining under control of a vehicle driver.

40. (canceled)

41. (canceled)

42. (canceled)

43. The latch of claim 39, wherein the blocking component is positionable in a first position corresponding to an unblocked position for the blocking component, and a second position corresponding to a blocked position for the blocking component, such that the blocking component is stable in both the first and second positions without continued receipt of the actuation signal or other energization in order to maintain the blocking component in either of the unblocked or blocked positions.

44. The latch of claim 43, wherein a multiple position biasing member retains the blocking component in either the first position or the second position.

45. (canceled)

46. (canceled)

47. (canceled)

48. (canceled)

49. (canceled)

50. The latch of claim 39, further comprising a detent in the pawl for engagement by the blocking component to provide said inhibit movement of the pawl to the ratchet release position.

51. The latch of claim 50, wherein a relative spaced apart position between the blocking component and the detent provides for a spatial separation between an engagement surface of the blocking component and a corresponding engagement surface of the detent when the blocking component is positioned to said inhibit movement of the pawl to the ratchet release position.

52. (canceled)

53. (canceled)

54. (canceled)

55. (canceled)

56. (canceled)

57. (canceled)

58. (canceled)

59. (canceled)

60. The method of claim 4, further comprising:
blocking release of a latch of a closure panel of the vehicle by positioning a blocking component of the latch when the wheel speed is above the first threshold, automatically without occupant intervention, into a blocking position adjacent to at least one latch component of the latch, to restrict movement of the at least one latch component which movement would cause the latch to open when the wheel speed is below a second threshold, automatically without occupant intervention, positioning the blocking component into a non-blocking position away from the at least one latch component to allow movement of the at least one latch component which movement would cause the latch to open.

61. The method of claim 8, further comprising:
determining whether an occupant is in the vehicle, whether a speed of the vehicle is above a first threshold, and whether a crash event has occurred; and,
when the occupant is in the vehicle, the speed is above the first threshold, and the crash event has not occurred, activating the blocking component to block release of the latch.

62. The method of claim 4 comprising:
determining whether a crash even has occurred;
when the crash event has not occurred, determining whether the speed has reduced to between the first threshold and a second threshold; and,
when the occupant is in the vehicle and the speed has reduced to between the first threshold and the second threshold, activating the blocking component to block release of the latch.

63. The method of claim 16, further comprising:
determining whether a crash event has occurred;
when the crash event has not occurred, determining whether the occupant is in the vehicle and whether the speed has reduced to between the first threshold and a second threshold; and,
when the occupant is in the vehicle and the speed has reduced to between the first threshold and the second threshold, activating the blocking component to block release of the latch.

64. The method of claim 4, further comprising:
when the blocking component has been activated to block release of the latch determining whether crash event has occurred; and,
when the crash event has occurred, confirming that the blocking component has been activated.

65. The method of claim 8, further comprising:
when the blocking component has been activated to block release of the latch determining whether a crash event has occurred; and
when the crash even has occurred, confirming that the blocking component has been activated.

66. The method of claim 8, further comprising:
when the crash event has occurred and the activation of the blocking component has been confirmed, determining whether a predetermined period of time has elapsed; and,
when the predetermined period of time has elapsed, deactivating the blocking component to allow release of the latch.

67. The method of claim 9, further comprising:
when the crash event has occurred and the activation of the blocking component has been confirmed, determining whether a predetermined period of time has elapsed; and,
when the predetermined period of time has elapsed, deactivating the blocking component to allow release of the latch.

68. The latch of claim 39, wherein the blocking mechanism is independent of the lock mechanism to block movement of the ratchet or the pawl.
